(19) United States
(12) Patent Application Publication
(10) Pub. No.: US 2024/0245112 A1
(43) Pub. Date: Jul. 25, 2024

(54) AEROSOL GENERATING DEVICE AND METHOD OF CONTROLLING THE SAME

(71) Applicant: KT&G CORPORATION, Daedeok-gu Daejeon (KR)

(72) Inventors: Won Kyeong LEE, Gyeonggi-do (KR); Jong Sub LEE, Gyeonggi-do (KR); Byung Sung CHO, Gyeonggi-do (KR)

(73) Assignee: KT&G CORPORATION, Daedeok-gu Daejeon (KR)

(21) Appl. No.: 17/928,258

(22) PCT Filed: Jul. 22, 2022
(86) PCT No.: PCT/KR2022/010778

§ 371 Date: Nov. 28, 2022

(30) Foreign Application Priority Data
Aug. 12, 2021 (KR) 10-2021-0106934
Nov. 4, 2021 (KR) 10-2021-0150849

(51) Int. Cl. A24F 40/05; A24F 40/10; A24F 40/50; B06B 1/02

(52) U.S. Cl. CPC A24F 40/05; A24F 40/10; A24F 40/50; B06B 1/0215; B06B 2201/77

(57) ABSTRACT

An aerosol generating device according to an embodiment including a storage unit in which an aerosol generating material is stored, a liquid delivery element configured to absorb the aerosol generating material stored in the storage unit, an atomizer including a vibrator configured to generate ultrasonic vibration and atomize the aerosol generating material absorbed by the liquid delivery element with an aerosol, and a processor configured to control power supplied to the vibrator, wherein the processor is further configured to sense an output value in response to a pulse signal having a certain frequency and set an operating frequency for preheating based on the sensed output value.

### TECHNICAL FIELD

Embodiments of the present disclosure relate to an aerosol generating device and a method of controlling the aerosol generating device, and more particularly, to an aerosol generating device using an ultrasonic vibrator and a method of controlling the aerosol generating device.

### BACKGROUND ART

There has been an increasing demand for a technology for replacing a method of supplying aerosols by burning general cigarettes. For example, studies on methods of generating aerosols from an aerosol generating material in a liquid or solid state or generating a vapor from an aerosol generating material in a liquid state and then supplying aerosols having flavors by passing the generated vapor through a fragrance medium in a solid state have been conducted.

### DISCLOSURE

### Technical Problem

Generally, in an aerosol generating device according to the related art, aerosols are generated by heating an aerosol generating material in a liquid or solid state by using a heater. It is significant to heat the aerosol generating material at an appropriate temperature in order to supply aerosols having excellent flavors to a user. In an aerosol generating device using a heater, the aerosol generating material is unintentionally heated at a high temperature so that the user may be provided a burnt taste in a smoking process.

In order to solve problems of the aerosol generating device using a heater, an aerosol generating device capable of generating aerosols using ultrasonic vibration has been suggested. In the aerosol generating device using ultrasonic vibration, aerosols can be generated by reducing the viscosity of an aerosol generating material in a liquid state using heat generated when an alternating voltage is applied to a vibrator, and by granulating the aerosol generating material using ultrasonic vibration generated in the vibrator.

Ultrasonic vibrators have a natural vibration frequency that can generate the best vibration efficiency, and the frequency suitable for the relevant natural vibration frequency needs to be output from a system of a device. However, because an error is inevitable in manufacturing and producing ultrasonic vibrators and the system will output a single frequency, there is a difference in an ultrasonic vibrator-based natural frequency and a system frequency, which causes degradation of the amount of atomization and overheating of ultrasonic vibrators.

### Technical Solution

Embodiments of the present disclosure relate to an aerosol generating device that may compensate for an error in manufacturing an ultrasonic vibrator and a frequency deviation occurring due to an elastic body for supporting the ultrasonic vibrator when a cartridge is assembled, and a method of controlling the aerosol generating device.

Objectives to be solved through embodiments of the present disclosure are not limited to the above-mentioned objectives, and unmentioned objectives will be clearly understood by those skilled in the art in a technical field to which embodiments belong, from the present specification and the accompanying drawings.

An aerosol generating device according to an embodiment of the present disclosure includes a storage unit in which an aerosol generating material is stored, a liquid delivery element configured to absorb the aerosol generating material stored in the storage unit, an atomizer including a vibrator configured to generate ultrasonic vibration and atomize the aerosol generating material absorbed by the liquid delivery element with an aerosol, and a processor configured to control power supplied to the vibrator, wherein the processor is further configured to sense an output value in response to a pulse signal having a certain frequency and set an operating frequency for preheating based on the sensed output value.

The processor may be further configured to sense an output value in response to a pulse signal having a certain frequency and set an operating frequency for preheating based on the sensed output value.

The operating frequency may be a frequency of the pulse signal for preheating the vibrator.

The processor may be further configured to output pulse signals having a plurality of frequencies for a test so as to set the operating frequency and set the operating frequency depending on whether each output value is within a threshold value.

The processor may be further configured to output a pulse signal having a frequency of a certain size, check an output value of power supplied to the vibrator, compare a target output value corresponding to a previously-stored operating frequency with the checked output value, and set the operating frequency according to a comparison result.

The processor may be further configured to output a pulse signal corresponding to the set operating frequency.

The aerosol generating device may further a sensing circuit configured to sense an output value of an input side of the vibrator.

The output value may be a current value or a voltage value sensed at the input side of the vibrator.

The processor may be further configured to convert the sensed current value or voltage value into a digital value and compare the converted digital value with the previously-stored digital value according to a frequency to set the operating frequency.

The operating frequency may be a value within a range of 2.7 MHz to 3.2 MHz.

A vibration frequency of the vibrator may be a value within a range of 2.6 MHz to 3.1 MHz.

A method of controlling an aerosol generating device according to another embodiment of the present disclosure includes outputting a pulse signal corresponding to a first frequency, checking an output value of power supplied to the vibrator, determining whether the output value is within a preset threshold range and setting an operating frequency according to a determination result.

When the output value is within the preset threshold range, the operating frequency may be set, and when the output value is not within the preset threshold value, a current frequency may be changed into a second frequency that is different from the first frequency, and an output value of power supplied to the vibrator may be checked.

A method of controlling an aerosol generating device according to another embodiment of the present disclosure includes outputting a pulse signal corresponding to a certain frequency, checking an output value of power supplied to a vibrator, comparing the checked output value with an output value of an output value table for each previously-stored frequency, and setting the operating frequency according to the comparison result.

### Advantageous Effects

In an aerosol generating device and a method of controlling the aerosol generating device according to embodiments of the present disclosure, an aerosol generating material may be granulated using a vibrator for generating ultrasonic vibration so that aerosols may be generated at a relatively low temperature when using a heater, and as such, a user's sense of smoking may be improved.

In addition, an error in manufacturing an ultrasonic vibrator and a frequency deviation occurring due to an elastic body for supporting the ultrasonic vibrator when a cartridge is assembled may be compensated for so that a difference between an ultrasonic vibrator-based natural frequency and a system frequency may be minimized so that the efficiency of the vibrator may be optimized.

In addition, even when the frequency characteristics of the vibrator are changed, a uniform amount of atomization may be provided to the user so that the user's sense of smoking may be improved.

The effects achieved by embodiments of the present disclosure are not limited to the above-mentioned effects, and unmentioned effects will be clearly understood by those skilled in the art in a technical field to which embodiments belong, from the present specification and the accompanying drawings.

### DESCRIPTION OF DRAWINGS

FIG. 1 is a block diagram of an aerosol generating device according to an embodiment.

FIG. 2 is a view schematically illustrating the aerosol generating device illustrated in FIG. 1.

FIG. 3 is a perspective view of a cartridge according to an embodiment:

FIG. 4 is an exploded perspective view of a cartridge according to an embodiment:

FIG. 5 is a schematic view of an aerosol generating device according to an embodiment:

FIG. 6 is a schematic view of a processor shown in FIG. 5:

FIG. 7 is a flowchart illustrating a frequency calibration method before preheating of an ultrasonic vibrator according to an embodiment:

FIG. 8 is a flowchart illustrating a frequency calibration method before preheating of an ultrasonic vibrator according to an embodiment:

FIG. 9 is a flowchart illustrating an example of a method of controlling an aerosol generating device using an ultrasonic vibrator according to another embodiment:

FIG. 10 is a graph illustrating a controlling method of power supplied to the ultrasonic vibrator shown in FIG. 9:

FIG. 11 is a flowchart illustrating another example of a method of controlling an aerosol generating device using an ultrasonic vibrator according to another embodiment;

FIG. 12 schematically illustrates a graph of time to power of an ultrasonic vibrator that operates in a puffing mode:

FIG. 13 is a graph illustrating a case where an event occurs in a puffing high state:

FIG. 14 is a graph illustrating a case where an event occurs in a puffing low state:

FIG. 15 is a flowchart illustrating another example of a method of controlling an aerosol generating device using an ultrasonic vibrator according to another embodiment:

FIG. 16 is a graph illustrating power versus time, in which a preheat mode is omitted;

FIG. 17 is a flowchart illustrating another example of a method of controlling an aerosol generating device using an ultrasonic vibrator according to another embodiment:

FIG. 18 is a graph illustrating a puff wait heat number described in FIG. 17;

FIG. 19 is a graph of time to power supplied to an ultrasonic vibrator when a puffing high time is set to zero; and

FIG. 20 is a flowchart illustrating a method of controlling an aerosol generating device using an ultrasonic vibrator according to another embodiment.

### MODE FOR INVENTION

With respect to the terms used to describe the various embodiments, the general terms which are currently and widely used are selected in consideration of functions of structural elements in the various embodiments of the present disclosure. However, meanings of the terms can be according to intention, a judicial precedence, the appearance of a new technology, and the like. In addition, in certain cases, a term which is not commonly used can be selected. In such a case, the meaning of the term will be described in detail at the corresponding portion in the description of the present disclosure. Therefore, the terms used in the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

The term “aerosol” described in the specification means a gas in a state in which vaporized particles generated from aerosol generating material and air are mixed.

In addition, the term “aerosol generating device” described in the specification means a device that generates the aerosol by using the aerosol generating material to generate the aerosol that can be inhaled directly into a user's lungs through the user's mouth.

The term “puff” described in the specification means inhalation by the user, and inhalation means a situation in which the aerosol is drawn into the user's mouth, nasal cavity, or lungs through the user's mouth or nose.

Hereinafter, embodiments of the present disclosure will now be described more fully with reference to the accompanying drawings, in which non-limiting example embodiments of the present disclosure are shown such that one of ordinary skill in the art may easily work the present disclosure.

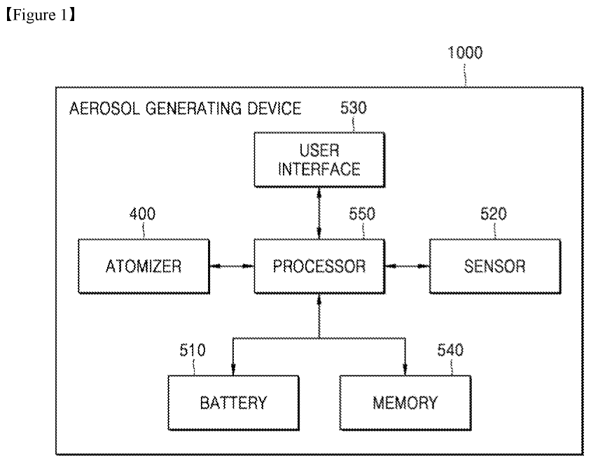

FIG. 1 is a block diagram of an aerosol generating device according to an embodiment.

Referring to FIG. 1, the aerosol generating device 1000 may include an atomizer 400, a battery 510, a sensor 520, a user interface 530, a memory 540, and a processor 550. However, the internal structure of the aerosol generating device 1000 is not limited to the structures illustrated in FIG. 1. According to the embodiment of the aerosol generating device 1000, it will be understood by one of ordinary skill in the art that some of the components shown in FIG. 1 may be omitted or new components may be added.

In an embodiment, the aerosol generating device 1000 may comprise or consist of only a main body, in which case components included in the aerosol generating device 1000 are located in the main body.

In another embodiment, the aerosol generating device 1000 may comprise or consist of a main body and a cartridge, in which case components included in the aerosol generating device 1000 are located separately in the main body and the cartridge. Alternatively, at least some of components included in the aerosol generating device 1000 may be located respectively in the main body and the cartridge.

Hereinafter, an operation of components will be described without being limited to the location in a particular space in the aerosol generating device 1000.

The atomizer 400 receives power from the battery 510 under the control of the processor 550. The atomizer 400 may receive power from the battery 510 and atomize the aerosol generating material stored in the aerosol generating device 1000.

The atomizer 400 may be located in the main body of the aerosol generating device 1000. Alternatively, when the aerosol generating device 1000 comprises or consists of the main body and the cartridge, the atomizer 400 may be located in the cartridge. When the atomizer 400 is located in the cartridge, the atomizer 400 may receive power from the battery 510 located in at least one of the main body and the cartridge. In addition, when the atomizer 400 is located separately in the main body and the cartridge, components requiring power supply in the atomizer 400 may receive power from battery 510 located in at least one of the main body and the cartridge.

The atomizer 400 generates aerosol from the aerosol generating material inside the cartridge. The aerosol may refer to a gas in which vaporized particles generated from the aerosol generating material are mixed with air. Therefore, the aerosol generated from the atomizer 400 means a gas in which vaporized particles generated from the aerosol generating material are mixed with air. For example, the atomizer 400 performs a function of generating aerosol by converting the phase of the aerosol generating material inside the cartridge 10 to a gaseous phase. In addition, the atomizer 400 generates an aerosol by discharging the aerosol generating material in a liquid and/or solid phase into fine particles.

For example, the atomizer 400 generates the aerosol from the aerosol generating material by using an ultrasonic vibration method. The ultrasonic vibration method means a method of generating the aerosol by atomizing the aerosol generating material with ultrasonic vibration generated by a vibrator.

Although not shown in FIG. 1, the atomizer 400 may optionally include a heater capable of heating the aerosol generating material by generating heating. The aerosol generating material may be heated by the heater, such that the aerosol may be generated.

The heater may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, or nichrome, but is not limited thereto. In addition, the heater may be implemented by a metal wire, a metal plate on which an electrically conductive track is arranged, or a ceramic heating element, but is not limited thereto.

In an embodiment, the heater may be a component included in the cartridge. The cartridge may include the heater, the liquid delivery element, and the liquid storage. The aerosol generating material accommodated in the liquid storage may be moved to the liquid delivery element, and the heater may heat the aerosol generating material absorbed by the liquid delivery element, thereby generating aerosol. For example, the heater may include a material such as nickel chromium and may be wound around or arranged adjacent to the liquid delivery element.

In another embodiment, the aerosol generating device 1000 may include an accommodation space accommodating the aerosol generating article. The heater may heat the aerosol generating article inserted into the accommodation space of the aerosol generating device 1000. As the aerosol generating article is accommodated in the accommodation space of the aerosol generating device 1000, the heater may be located inside and/or outside the aerosol generating article. Accordingly, the heater may generate aerosol by heating the aerosol generating material in the aerosol generating article.

Meanwhile, the heater may include an induction heater. The heater may include an electrically conductive coil for heating an aerosol generating article in an induction heating method, and the aerosol generating article or the cartridge may include a susceptor which may be heated by the induction heater.

The battery 510 supplies power to be used for the aerosol generating device 1000 to operate. In other words, the battery 510 may supply power such that the heater may be heated. In addition, the battery 510 may supply power for operation of other components included in the aerosol generating device 1000, that is, the sensor 520, the user interface 530, the memory 540, and the processor 550. The battery 510 may be a rechargeable battery or a disposable battery.

For example, the battery 510 is a lithium-ion battery, a nickel-based battery (for example, a nickel-metal hydride battery, a nickel-cadmium battery), or a lithium-based battery (for example, a lithium-cobalt battery, a lithium-Phosphate battery, lithium titanate battery or lithium-polymer battery). However, the type of the battery 510 can be used in the aerosol generating device 1000 is not limited by the above description. According to embodiments, the battery 510 may include an alkaline battery or a manganese battery.

The aerosol generating device 1000 may include at least one sensor 520. A result sensed by the at least one sensor 520 is transmitted to the processor 550, and the processor 550 may control the aerosol generating device 1000 to perform various functions such as controlling the operation of the heater, restricting smoking, determining whether an aerosol generating article (or a cartridge) is inserted, and displaying a notification.

For example, the at least one sensor 520 may include a puff sensor. The puff sensor may detect a user's puff based on any one of a temperature change, a flow change, a voltage change, and a pressure change. The puff sensor may detect a start timing and an end timing of the user's puff, and the processor 550 may determine a puff period and a non-puff period according to the detected start timing and end timing of the puff.

In addition, the at least one sensor 520 may include a user input sensor. The user input sensor may be a sensor capable of receiving a user's input, such as a switch, a physical button, or a touch sensor. For example, the touch sensor may be a capacitive sensor capable of detecting a user's input by detecting a change in capacitance when the user touches a predetermined area formed of a metal material. The processor 550 may determine whether a user's input has occurred by comparing values before and after a change in capacitance received from the capacitive sensor. When the value before and after the change of capacitance exceeds the preset threshold, the processor 550 may determine that the user's input has occurred.

In addition, the at least one sensor 520 may include a motion sensor. The aerosol generating device 1000 may obtain information about the movement of the aerosol generating device 1000 such as inclination, moving speed, and acceleration of the aerosol generating device 1000 through the motion sensor. For example, the motion sensor may detect information regarding a state in which the aerosol generating device 1000 is moving, a state in which the aerosol generating device 1000 is stopped, a state in which the aerosol generating device 1000 is inclined at an angle within a predetermined range for puff, and a state in which the aerosol generating device 1000 is inclined at an angle different from that during the puff operation may be measured between each puff operation. The motion sensor may detect motion information of the aerosol generating device 1000 using various methods known in the art. For example, the motion sensor may include an acceleration sensor capable of measuring acceleration in three directions, an x-axis, a y-axis, and a z-axis, and a gyro sensor capable of measuring angular velocity in the three directions.

In addition, the at least one sensor 520 may include a proximity sensor. The proximity sensor means a sensor that may detect a presence or distance of an approaching object or an object existing in the vicinity without mechanical contact using the force of an electromagnetic field or infrared rays, etc. The aerosol generating device 1000 may detect whether the user approaches the aerosol generating device 1000 by using the proximity sensor.

In addition, the at least one sensor 520 may include an image sensor. For example, the image sensor may include a camera for acquiring an image of an object. The image sensor may recognize an object based on an image acquired by the camera. The processor 550 may determine whether the user is in a situation for using the aerosol generating device 1000 by analyzing the image acquired by the image sensor. For example, when the user's lips approach the aerosol generating device 1000 to use the aerosol generating device 1000, the image sensor may acquire an image of the lips. The processor 550 may determine that the user is in a situation to use the aerosol generating device 1000 based on determination that the acquired image includes lips. Through the above-described operation of the processor 550, the aerosol generating device 1000 may operate the atomizer 400 in advance or preheat the heater.

In addition, the at least one sensor 520 may include a consumable detachment sensor capable of detecting installation or removal of consumables (e.g., cartridge, aerosol generating article, etc.) that can be used in the aerosol generating device 1000. For example, the consumables detachment sensor may detect whether the consumables are in contact with the aerosol generating device 1000 or determine based on the image sensor whether the consumables are detached. In addition, the consumable detachment sensor may be an inductance sensor that detects a change in the inductance value of a coil capable of interacting with a marker of the consumable, or a capacitance sensor that detects a change in the capacitance value of a capacitor capable of interacting with the marker of the consumable.

In addition, the at least one sensor 520 may include a temperature sensor. The temperature sensor may detect the temperature at which the heater of the atomizer 400 (or an aerosol generating material) is heated. The aerosol generating device 1000 may include a separate temperature sensor for sensing a temperature of the heater, or the heater itself may serve as a temperature sensor instead of including a separate temperature sensor. Alternatively, a separate temperature sensor may be further included in the aerosol generating device 1000 while the heater serves as a temperature sensor. In addition, the temperature sensor may sense the temperature of internal components such as a printed circuit board (PCB) and a battery of the aerosol generating device 1000 as well as the heater.

In addition, the at least one sensor 520 may include various sensors that measure information on the surrounding environment of the aerosol generating device 1000. For example, the at least one sensor 520 may include a temperature sensor that can measure the temperature of the surrounding environment, a humidity sensor that measures the humidity of the surrounding environment, and an atmospheric pressure sensor that measures the pressure of the surrounding environment.

The at least one sensor 520 that may be provided in the aerosol generating device 1000 is not limited to the above-described types, and may further include various other sensors. For example, the aerosol generating device 1000 includes a fingerprint sensor capable of acquiring fingerprint information from a user's finger for user authentication and security, an iris recognition sensor capable of analyzing the iris pattern of the pupil, a veil recognition sensor that detect the amount of infrared absorption of hemoglobin from an image of a palm, a facial recognition sensor that recognizes feature points such as eyes, nose, mouth, and facial contour in a two-dimensional (2D) or a three-dimensional (3D) method, and a Radio-Frequency Identification (RFID) sensor, etc.

In the aerosol generating device 1000, any number of the examples of the various sensors described above may be selected and implemented. In other words, the aerosol generating device 1000 may combine and utilize information sensed by the above-described at least one sensor.

The user interface 530 may provide the user with information about the state of the aerosol generating device 1000. The user interface 530 may include various interfacing devices, such as a display or a light emitter for outputting visual information, a motor for outputting haptic information, a speaker for outputting sound information, input/output (I/O) interfacing devices (e.g., a button or a touch screen) for receiving information input from the user or outputting information to the user, terminals for performing data communication or receiving charging power, and communication interfacing modules for performing wireless communication (e.g., Wi-Fi, Wi-Fi direct, Bluetooth, near-field communication (NFC), etc.) with external devices.

The aerosol generating device 1000 may be implemented by selecting any number of the above-described examples of the user interface 530.

The memory 540, as a hardware component configured to store various pieces of data processed in the aerosol generating device 1000, may store data processed or to be processed by the processor 550. The memory 540 may include various types of memories: random access memory (RAM), such as dynamic random access memory (DRAM) and static random access memory (SRAM), etc.; read-only memory (ROM): electrically erasable programmable read-only memory (EEPROM), etc.

The memory 540 may store an operation time of the aerosol generating device 1000, the maximum number of puffs, the current number of puffs, at least one temperature profile, data on a user's smoking pattern, etc.

The processor 550 may generally control operations of the aerosol generating device 1000. The processor 550 can be implemented as an array of a plurality of logic gates or can be implemented as a combination of a general-purpose microprocessor and a memory in which a program executable in the microprocessor is stored, the program configured to cause the microprocessor to perform the functions of the processor 550. It will be understood by one of ordinary skill in the art that the processor 550 can be implemented in other forms of hardware.

The processor 550 analyzes a result of the sensing by at least one sensor 520, and controls the processes that are to be performed subsequently.

The processor 550 may control power supplied to the atomizer 400 so that the operation of the atomizer 400 is started or terminated, based on the result of the sensing by the at least one sensor 520. In addition, based on the result of the sensing by the at least one sensor 520, the processor 550 may control the amount of power supplied to the atomizer 400 and the time at which the power is supplied, so that the atomizer 400 is heated to a predetermined temperature or maintained at an appropriate temperature. For example, the processor 550 may control the power or voltage supplied to the atomizer 400, so that the vibrator of the atomizer 400 may vibrate at a predetermined frequency.

In an embodiment, the processor 550 may start the operation of the atomizer 400 after receiving a user input to the aerosol generating device 1000. In addition, the processor 550 may start the operation of the atomizer after detecting a user's puff by using the puff sensor. In addition, the processor 550 may stop supplying power to the atomizer 400 when the number of puffs reaches a preset number after counting the number of puffs by using the puff sensor.

The processor 550 may control the user interface 530 based on the result of the sensing by the at least one sensor 520. For example, when the number of puffs reaches the preset number after counting the number of puffs by using the puff sensor, the processor 550 may notify the user, by using at least one of a light emitter, a motor, or a speaker, that operation of the aerosol generating device 1000 will soon be terminated.

Although not illustrated in FIG. 1, the aerosol generating device 1000 may form an aerosol generating system together with an additional cradle. For example, the cradle may be used to charge the battery 510 of the aerosol generating device 1000. For example, while the aerosol generating device 1000 is accommodated in an accommodation space of the cradle, the aerosol generating device 1000 may receive power from a battery of the cradle such that the battery 510 of the aerosol generating device 1000 may be charged.

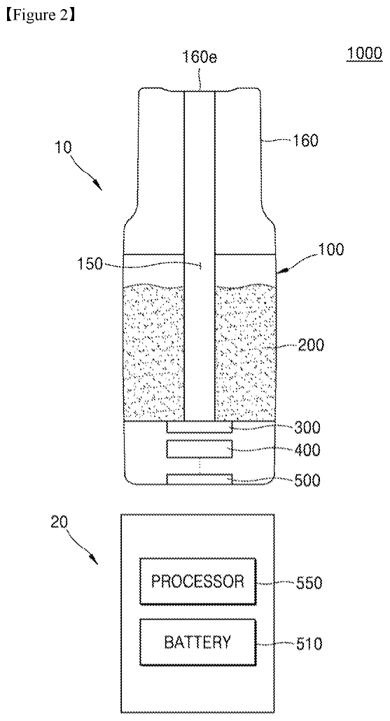

FIG. 2 is a view schematically illustrating the aerosol generating device according to the embodiment.

At least one of the components of the aerosol generating device 1000 shown in FIG. 2 may be the same as or similar to at least one of the components of the aerosol generating device 1000 shown in FIG. 1, and thus, redundant descriptions will be omitted.

Referring to FIG. 2, the aerosol generating device 1000 includes a cartridge 10 for storing the aerosol generating material and a main body 20 that supports the cartridge 10.

The cartridge 10 may be coupled to the main body 20 in a state of accommodating an aerosol generating material therein. For example, by inserting at least a portion of the cartridge 10 into the main body 20, the cartridge 10 may be coupled to the main body 20. As another example, by inserting at least a portion of the main body 20 into the cartridge 10, the cartridge 10 may be coupled to the main body 20.

The cartridge 10 and the main body 20 may be coupled to each other by at least one of a snap-fit method, a screw connection method, a magnetic force coupling method, or a forcible fitting method, but a method of coupling the cartridge 10 and the main body 20 is not limited to the examples described above.

According to an embodiment, the cartridge 10 may include a housing 100, a mouthpiece 160, a storage unit 200, a liquid delivery element 300, the atomizer 400, and a printed circuit board 500.

The housing 100 may form an overall outer shape of the cartridge 10 together with the mouthpiece 160, and the components for the operation of the cartridge 10 may be arranged in the housing 100. In an embodiment, the housing 100 may be formed in a rectangular shape, but the shape of the housing 100 is not limited to the embodiment described above. According to an embodiment, the housing 100 may be formed in a polygonal column (e.g., a triangular column, a pentagon column) shape or a cylindrical shape.

The mouthpiece 160 is arranged in an area of the housing 100, and may include an outlet 160e for discharging the aerosol generated from the aerosol generating material to the outside. In one embodiment, the mouthpiece 160 may be disposed in another area located in a direction opposite to the area of the cartridge 10 that is coupled to the main body 20, and the user may be provided with aerosol from the cartridge 10 by contacting their mouth with the mouthpiece 160 and inhaling.

Through the inhalation or puffing actions of the user, a difference in pressure may occur between the outside of the cartridge 10 and the inside of the cartridge 10, and through the difference in pressure between the outside of the cartridge 10 and the inside of the cartridge 10, an aerosol generated from the inside of the cartridge 10 may be discharged to the outside of the cartridge 10 through the outlet 160e. Thus, the user may be provided with aerosol discharged to the outside of the cartridge 10 through the outlet 160e by contacting their mouth with the mouthpiece 160 and inhaling.

The storage unit 200 may be located in an inner space of the housing 100 and may accommodate the aerosol generating material. In the present disclosure, the expression “the storage unit accommodates the aerosol generating material” means that the storage unit 200 may simply accommodate the aerosol generating material by being a container, or the storage unit 200 may include an element impregnated with (containing) an aerosol generating material, such as a sponge, cotton, fabric, or porous ceramic structure. Further, the above expression may be used with the same meaning here below.

The storage unit 200 may accommodate an aerosol generating material having any one state of, for example, a liquid, solid, gas, gel, or the like.

In an embodiment, the aerosol generating material may include a liquid composition. The liquid composition may be a liquid including a tobacco-containing material having a volatile tobacco flavor component, or a liquid including a non-tobacco material.

The liquid composition may include, for example, any one component of water, solvents, ethanol, plant extracts, spices, flavorings, and vitamin mixtures, or a mixture thereof. The spices may include menthol, peppermint, spearmint oil, and various fruit-flavored ingredients, but are not limited thereto.

The flavorings may include ingredients capable of providing various flavors or tastes to a user. Vitamin mixtures may be a mixture of at least one of vitamin A, vitamin B, vitamin C, and vitamin E, but are not limited thereto. In addition, the liquid composition may include an aerosol forming agent such as glycerin and propylene glycol.

For example, the liquid composition may include any weight ratio of glycerin and propylene glycol solution to which nicotine salts are added. The liquid composition may include two or more types of nicotine salts. Nicotine salts may be formed by adding suitable acids, including organic or inorganic acids, to nicotine. Nicotine may be a naturally generated nicotine or synthetic nicotine and may have any suitable weight concentration relative to the total solution weight of the liquid composition.

Acid for forming nicotine salts may be appropriately selected in consideration of the rate of nicotine absorption in blood, operating temperature of the aerosol generating device 1000, the flavor or savor, the solubility, or the like. For example, the acid for the formation of nicotine salts may be a single acid selected from the group consisting of benzoic acid, lactic acid, salicylic acid, lauric acid, sorbic acid, levulinic acid, pyruvic acid, formic acid, acetic acid, propionic acid, butyric acid, valeric acid, caproic acid, caprylic acid, capric acid, citric acid, myristic acid, palmitic acid, stearic acid, oleic acid, linoleic acid, linolenic acid, phenylacetic acid, tartaric acid, succinic acid, fumaric acid, gluconic acid, saccharic acid, malonic acid or malic acid, or a mixture of two or more acids selected from the group, but is not limited thereto.

The atomizer 400 may be located inside the housing 100 and may convert a phase of the aerosol generating material stored in the cartridge 10 to generate aerosol.

For example, the aerosol generating material stored or accommodated in the storage unit 200 may be supplied from the storage unit 200 to the atomizer 400 through the liquid delivery element 300, and the atomizer 400 may generate aerosol by atomizing the aerosol generating material received from the liquid delivery element 300. At this time, the liquid delivery element 300 may be a wick including at least one of cotton fiber, ceramic fiber, glass fiber, and porous ceramic, but the liquid delivery element 300 is not limited to the embodiments described above.

According to one embodiment, the atomizer 400 of the aerosol generating device 1000 may convert the phase of the aerosol generating material by using an ultrasonic vibration method that atomizes the aerosol generating material with ultrasonic vibration.

For example, the atomizer 400 may include a vibrator that generates short periods of vibrations, and the vibrations generated from the vibrator may be ultrasonic vibrations. The frequency of the ultrasonic vibrations may be about 100 kHz to about 3.5 MHz, but is not limited thereto.

The aerosol generating material supplied to the atomizer 400 from the storage unit 200 by short periods of vibrations generated from the vibrator may be vaporized and/or changed to particles and atomized to an aerosol.

The vibrator may include, for example, a piezoelectric ceramic, and the piezoelectric ceramic may, by generating electricity (voltage) by a physical force (pressure), and generating vibration (mechanical force) when electricity is applied thereto, act as a functional material capable of converting electrical and mechanical forces into one another. That is, as electricity is applied to the vibrator, vibrations (physical force) of short periods may be generated, and the generated vibrations break down the aerosol generating material to small particles to thereby atomize to an aerosol.

The vibrator may be electrically connected to other components of the aerosol generating device 1000 through an electrical connection member.

According to an embodiment, the vibrator may be electrically connected with at least one of a battery 510 (e.g., the battery 510 of FIG. 1), a processor 550 (e.g., the processor 550 of FIG. 1), and a driving circuit of the aerosol generating device 1000 through a printed circuit board 500 located inside the housing 100 of the cartridge 10. For example, the vibrator may be electrically connected to the printed circuit board 500 located inside the cartridge 10 through the first electrical connection member, and the printed circuit board 500 may be electrically connected to the battery 510, the processor 550, and/or other driving circuits of the main body 20 through the second electrical connection member. That is, the vibrator may be electrically connected to the components of the main body 20 via the printed circuit board 500.

According to another embodiment (not shown), the vibrator may be directly connected to at least one of the battery 510 and the processor 550 of the main body 20 and the driving circuit of the aerosol generating device 1000, without the printed circuit board 500 as a medium for connection.

The vibrator may generate ultrasonic vibration by receiving currents or voltages from the battery 510 of the main body 20 through the electrical connection member. In addition, the vibrator may be electrically connected to the processor 550 of the main body 20 through the electrical connection member, and the processor 550 may control the operation of the vibrator.

The electrical connection member may include, for example, a pogo pin, a wire, a cable, a flexible printed circuit board (FPCB), and a C-clip, but the electrical connection member is not limited to the examples described above.

In another embodiment (not shown), the atomizer 400 may be implemented as a mesh shape or plate shape vibration accommodation portion that performs a function of absorbing the aerosol generating material without using a separate liquid delivery element 300 and maintaining the aerosol generating material in an optimal state for conversion to an aerosol, and a function of transmitting vibration to the aerosol generating material and generating an aerosol.

The aerosol generated by the atomizer 400 may be discharged to the outside of the cartridge 10 through a discharge passage 150 and supplied to the user.

According to an embodiment, the discharge passage 150 may be located inside the cartridge 10 and may be connected to or communicate with the atomizer 400 and the outlet 160e of the mouthpiece 160. Accordingly, the aerosol generated in the atomizer 400 may flow along the discharge passage 150 and may be discharged to the outside of the cartridge 10 or the aerosol generating device 1000 through the outlet 160e. The user may be supplied with the aerosol by contacting their mouth with the mouthpiece 160 and inhaling the aerosol being discharged from the outlet 160e.

For example, the discharge passage 150 may be arranged such that the outer circumferential surface thereof is surrounded by the storage unit 200 inside the housing 100. However, the arrangement of the discharge passage 150 is not limited to the example described above.

Although not shown in the drawing, the cartridge 10 may include at least one air entry passage for air (hereinafter referred to as external air) outside of the cartridge 10 or the aerosol generating device 1000 to flow into the housing 100.

The external air may flow through at least one air entry passage into a space in which aerosols are generated by the discharge passage 150 or the atomizer 400 inside the cartridge 10. The introduced external air may be mixed with vaporized particles generated from the aerosol generating material, and as a result, aerosols may be generated.

According to an embodiment, the cross-sectional shape in a direction transverse to the longitudinal direction of the cartridge 10 and/or the main body 20 of the aerosol generating device 1000 may be circular, elliptical, square, rectangular, or other various types of polygons. However, the cross-sectional shape of the cartridge 10 and/or the main body 20 may not be limited to the shape described above, and the aerosol generating device 1000 may not extend in a straight line in the longitudinal direction.

In another embodiment, the cross-sectional shape of the aerosol generating device 1000 may be curved in a streamline shape for the user to comfortably hold the aerosol generating device 1000 or may be bent in a predetermined angle at a certain area and elongated, and the cross-sectional shape of the aerosol generating device 1000 may change along the longitudinal direction.

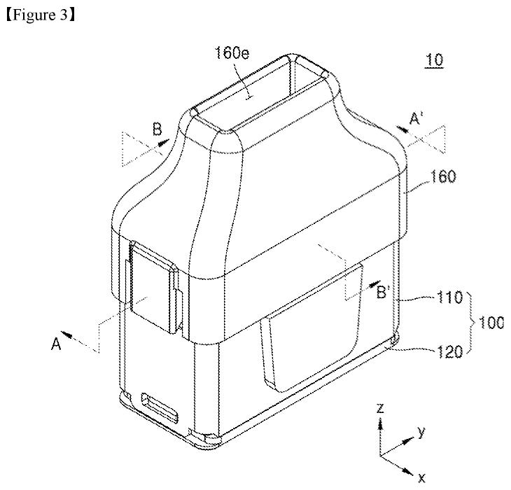

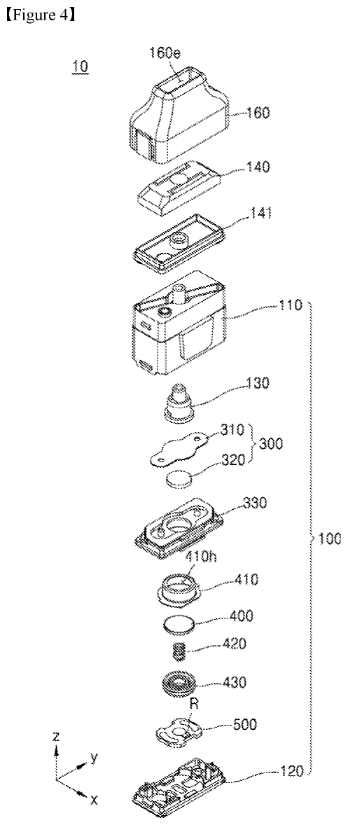

FIG. 3 is a perspective view of a cartridge according to an embodiment, and FIG. 4 is an exploded perspective view of a cartridge according to an embodiment.

A cartridge 10 according to the embodiment shown in FIGS. 3 and 4 may be an embodiment of the cartridge 10 of the aerosol generating device 1000 shown in FIG. 2, and a redundant description thereof will be omitted.

Referring to FIGS. 3 and 4, the cartridge 10 according to an embodiment may include a housing 100, a discharge passage 150 (refer to FIG. 2), a mouthpiece 160, a storage unit 200 (also referred to as a “storage unit”) (refer to FIG. 2), a liquid delivery element 300, an atomizer 400, and a printed circuit board 500. Elements of the cartridge 10 according to an embodiment are not limited to the above-described example, and one configuration may be added, or one configuration (e.g., the mouthpiece 160) may be omitted depending on an embodiment.

The housing 100 may form an inner space in which components of the cartridge 10 may be arranged while forming the overall appearance of the cartridge 10. In the drawings, only embodiments in which the housing 100 of the cartridge 10 has an overall rectangular pillar shape, are shown. However, embodiments of the present disclosure are not limited thereto. In another embodiment (not shown), the housing 100 may be formed in an overall cylindrical shape or a polygonal pillar shape (e.g., a triangular pillar, a pentagon pillar).

According to an embodiment, the housing 100 may include a first housing 110 and a second housing 120 connected to one region of the first housing 110, and the first housing 110 and the second housing 120 may protect components of the cartridge 10 arranged in the inner space formed by combination of the first housing 110 and the second housing 120.

For example, the first housing 110 (or an ‘upper housing’) may be combined with one region on an upper end (e.g., a z direction) of the second housing 120 (or a ‘lower housing’) so that the inner space in which components of the cartridge 10 may be arranged, may be formed between the first housing 110 and the second housing 120. However, embodiments of the present disclosure are not limited thereto.

In the present disclosure, an ‘upper end’ may mean a ‘z’ direction of FIGS. 3 and 4, and a ‘lower end’ may mean a ‘-z’ direction of FIGS. 3 and 4 that is opposite to the upper end, and corresponding expressions may also be used in the same sense as below.

The mouthpiece 160, that is a portion inserted into the user's mouth, may be connected to one region of the housing 100. For example, the mouthpiece 160 may be connected to another region (e.g., an upper end of the first housing 110) in an opposite direction to a direction of one region of the first housing 110 connected to the second housing 120.

In an embodiment, the mouthpiece 160 may be detachably combined with one region of the housing 100. However, the mouthpiece 160 may be integrally formed with the housing 100 depending on an embodiment.

The mouthpiece 160 may include at least one outlet 160e (e.g., at least one discharge hole) for discharging aerosols generated inside the cartridge 10 to an outside of the cartridge 10. The user's oral cavity may be in contact with the mouthpiece 160, and the user may receive aerosols discharged to the outside through the outlet 160e of the mouthpiece 160.

The storage unit 200 may be arranged in the inner space of the first housing 110, and an aerosol generating material may be stored in the storage unit 200. For example, an aerosol generating material in a liquid state may be stored in the storage unit 200. However, embodiments of the present disclosure are not limited thereto.

The liquid delivery element 300 may be positioned between the storage unit 200 and the atomizer 400, and the aerosol generating material stored in the storage unit 200 may be supplied to the atomizer 400 through the liquid delivery element 300.

According to an embodiment, the liquid delivery element 300 may receive the aerosol generating material from the storage unit 200 and may deliver the received aerosol generating material to the atomizer 400. For example, the liquid delivery element 300 may absorb the aerosol generating material that moves from the storage unit 200 to the liquid delivery element 300, and the absorbed aerosol generating material may be moved along the liquid delivery element 300 and supplied to the atomizer 400.

According to an embodiment, the liquid delivery element 300 may include a plurality of liquid delivery elements. For example, the liquid delivery element 300 may include a first liquid delivery element 310 and a second liquid delivery element 320.

The first liquid delivery element 310 may be disposed adjacent to the storage unit 200 and may receive the aerosol generating material in the liquid state from the storage unit 200. For example, the first liquid delivery element 310 may absorb at least a portion of the aerosol generating material discharged from the storage unit 200 and may receive the aerosol generating material from the storage unit 200.

For example, the aerosol generating material stored in the storage unit 200 may be discharged to the outside of the storage unit 200 through a liquid supply hole (not shown) formed in one region of the storage unit 200 toward the first liquid delivery element 310.

The second liquid delivery element 320 may be positioned between the first liquid delivery element 310 and the atomizer 400, and may deliver the aerosol supplied to the first liquid delivery element 310 to the atomizer 400. For example, the second liquid delivery element 320 may be positioned on a lower end (e.g., −z direction) of the first liquid delivery element 310 and may supply the aerosol generating material absorbed onto the first liquid delivery element 310 to the atomizer 400.

In an embodiment, one region of the second liquid delivery element 320 may be in contact with one region toward the −z direction of the first liquid delivery element 310, and another region of the second liquid delivery element 320 may be in contact with one region toward the z direction of the atomizer 400.

That is, the atomizer 400, the second liquid delivery element 320, and the first liquid delivery element 310 may be sequentially arranged in a lengthwise direction of the cartridge 10 or the housing 100. As such, the second liquid delivery element 320 and the first liquid delivery element 310 may be sequentially stacked on the atomizer 400.

Through the above-described arrangement structure, at least a portion of the aerosol generating material supplied from the storage unit 200 to the first liquid delivery element 310 may be moved to the second liquid delivery element 320 contacting the first liquid delivery element 310. In addition, the aerosol generating material that has moved to the second liquid delivery element 320 may move along the second liquid delivery element 320 and reach the atomizer 400 in contact with the second liquid delivery element 320.

In the drawings, only an embodiment including two liquid delivery elements of the liquid delivery element 300 is shown. However, the liquid delivery element 300 may include one liquid delivery element or three or more liquid delivery elements depending on an embodiment.

The atomizer 400 may atomize the aerosol generating material in a liquid state supplied from the liquid delivery element 300 to generate an aerosol.

For example, the atomizer 400 may include a vibrator for generating ultrasonic vibration. The frequency of ultrasonic vibration generated in the vibrator may be about 100 kHz to 10 MHZ, preferably, about 100 KHz to 3.5 MHz. As the vibrator generates the ultrasonic vibration of a frequency band described above, the vibrator may vibrate in the lengthwise direction (e.g., a z or −z direction) of the cartridge 10 or the housing 100. However, embodiments are not limited to a direction in which the vibrator vibrates, and the direction in which the vibrator vibrates, may be changed into various directions (one of z and −z direction, x and −x direction, and y and −y direction or a combination thereof).

The atomizer 400 may atomize the aerosol generating material in an ultrasonic manner, thereby generating an aerosol at a relatively low temperature compared to a method of heating an aerosol generating material. For example, in the case of a method of generating an aerosol generating material using a heater, a situation in which the aerosol generating material is heated at a temperature of 200° C. or more, may occur so that the user may have a burnt taste of the aerosol.

On the other hand, the cartridge 10 according to an embodiment may atomize the aerosol generating material in an ultrasonic manner so that an aerosol may be generated in the temperature range of about 100° C. to about 160° C. that is a low temperature compared to heating using the heater. Thus, the cartridge 10 may minimize the burnt taste of the aerosol so that the user's sense of smoking may be improved.

In the present disclosure, the “sense of smoking” may mean a sense in which users feel in a smoking process, and the corresponding expression may be used in the same sense below.

The atomizer 400 may be electrically connected to an external power source (e.g., the battery 510 positioned inside the main body 20 of FIG. 2) through the printed circuit board 500, and may generate ultrasonic vibration by power supplied from the external power source. For example, the atomizer 400 may be electrically connected to the printed circuit board 500 positioned inside the cartridge 10, and as the printed circuit board 500 is electrically connected to the external power source of the cartridge 10, the atomizer 400 may receive power from the external power source.

According to an embodiment, the atomizer 400 may be electrically connected to the printed circuit board 500 through a first conductor 410 and a second conductor 420.

In an embodiment, the first conductor 410 may include a material (e.g., metal) having electrical conductivity and may be positioned on an upper end of the atomizer 400 to electrically connect the atomizer 400 to the printed circuit board 500.

For example, a portion (e.g., an upper end) of the first conductor 410 may be arranged to surround at least one region of an outer circumferential surface of the atomizer 400 and may be in contact with the atomizer 400, and another portion (e.g., a lower end) of the first conductor 410 may extend in a direction toward the printed circuit board 500 to be in contact with one region of the printed circuit board 500. The atomizer 400 and the printed circuit board 500 may be electrically connected to each other by the above-described contact structure of the first conductor 410.

In an embodiment, an opening 410h may be formed in one portion of the first conductor 410 so that at least a portion of the atomizer 400 may be exposed to the outside of the first conductor 410. One region of the atomizer 400 exposed to the outside of the first conductor 410 through the opening 410h of the first conductor 410 may be in contact with the second liquid delivery element 320 and may receive the aerosol generating material from the second liquid delivery element 320.

In an embodiment, the second conductor 420 may include a material having electrical conductivity and may be positioned on a lower end of the atomizer 400 or between the atomizer 400 and the printed circuit board 500 to electrically connect the atomizer 400 to the printed circuit board 500. For example, as the second conductor 420 has an end contacting a lower end of the atomizer 400, and another end contacting one region toward the atomizer 400 of the printed circuit board 500, the atomizer 400 and the printed circuit board 500 may be electrically connected to each other.

According to an embodiment, the second conductor 420 may include a conductive material having elasticity, may electrically connect the atomizer 400 to the printed circuit board 500, and may elastically support the atomizer 400. For example, the second conductor 420 may include a conductive spring, but the second conductor 420 is not limited to the above-described embodiment.

The cartridge 10 according to an embodiment may further include an elastic support body 430 that is positioned between the atomizer 400 and the printed circuit board 500 and supports the second conductor 420. The elastic support body 430 may include, for example, a material having flexible characteristics, may be arranged to surround an outer circumferential surface of the second conductor 420, and may elastically support the second conductor 420. However, embodiments of the cartridge 10 are not limited thereto, and the elastic support body 430 may also be omitted depending on an embodiment.

According to an embodiment, the printed circuit board 500 may be positioned inside the second housing 120, may be electrically connected to the atomizer 400 through the first conductor 410 and the second conductor 420, and simultaneously may be electrically connected to an external power source (e.g., the battery 510 of FIG. 2) through an electrical connection member (not shown).

The electrical connection member may include at least one of a pogo pin, a wire, a cable, a flexible printed circuit board (FPCB), and a C-clip, but the electrical connection member is not limited to the above examples.

In an embodiment, the second housing 120 may include a plurality of through holes through which the inside of the second housing 120 and the outside of the cartridge 10 pass, and the electrical connection member may be disposed in the plurality of through holes and may electrically connect the printed circuit board 500 positioned inside the cartridge 10 to the external power source of the cartridge 10.

As the printed circuit board 500 is electrically connected to the atomizer 400 using the first conductor 410 and the second conductor 420 and is electrically connected to the external power source of the cartridge 10 using the electrical connection member, the atomizer 400 may be electrically connected to the external power source via the printed circuit board 500 and may receive power from the external power source.

A resistor R for removing noise (or a ‘noise signal’) generated during the operation process of the cartridge 10 may be mounted in at least one region of the printed circuit board 500, and the above-described resistor R may prevent damage of the atomizer 400 by removing noise. A detailed description of an operation of removing noise using the resistor R will be provided later.

The aerosol atomized by ultrasonic vibration generated by the atomizer 400 may be discharged to the outside of the cartridge 10 through the discharge passage 150 and may be supplied to the user. For example, the discharge passage 150 may be formed to connect or communicate the inner space of the housing 100 to or with the outlet 160e of the mouthpiece 160 so that the aerosol generated by the atomizer 400 may flow along the discharge passage 150 and then may be discharged to the outside of the cartridge 10.

According to an embodiment, the discharge passage 150 may be positioned in the inner space of the housing 100, and at least one region of the outer circumferential surface of the discharge passage 150 may be arranged to be surrounded by the storage unit 200. However, embodiments are not limited thereto.

The cartridge 10 according to an embodiment may further include a sealing unit 130 for preventing leakage generated from the storage unit 200 from being introduced into the discharge passage 150.

As the outer circumferential surface of the discharge passage 150 is disposed to be surrounded by the storage unit 200, a case where the leakage generated from the storage unit 200 is introduced into the discharge passage 150 so that the user's sense of smoking is lowered may occur in comparative embodiments.

On the other hand, the cartridge 10 according to an embodiment may prevent the leakage generated from the storage unit 200 from being introduced into the discharge passage 150 through the sealing unit 130 so that the user's sense of smoking may be prevented from being lowered.

In an embodiment, the sealing unit 130 may be positioned inside the discharge passage 150 and may prevent the leakage from being introduced into the discharge passage 150. For example, the sealing unit 130 may be fitted into the discharge passage 150 to be in close contact with inner walls of the discharge passage 150. However, embodiments are not limited thereto.

In addition, the sealing unit 130 may have an empty hollow shape therein and may prevent the leakage generated from the storage unit 200 from being introduced into the discharge passage 150 so that the flow of the aerosol generated from the atomizer 400 may not be disturbed.

In another embodiment, the sealing unit 130 may include a material (e.g., rubber) having elasticity and may absorb ultrasonic vibration generated from the atomizer 400. As such, it may be minimized that ultrasonic vibration generated from the atomizer 400 is delivered to the user via the housing 100 of the cartridge 10.

In another embodiment, the sealing unit 130 may be positioned on an upper end of the liquid delivery element 300 and may press the liquid delivery element 300 in a direction toward the atomizer 400 so that contact of the liquid delivery element 300 and the atomizer 400 may be maintained. For example, the sealing unit 130 may press the first liquid delivery element 310 and/or the second liquid delivery element 320 in a −z direction so that contact between the second liquid delivery element 320 and the atomizer 400 may be maintained.

The cartridge 10 according to an embodiment may further include a structure 140 for preventing droplets sprung up from the atomizer 400 from being supplied to the user, and a first support unit 141 that fixes or supports the structure 140.

Some aerosol generating materials may not be atomized in the process of being atomized by ultrasonic vibration generated by the atomizer 400 so that droplets may be generated, and the case where the generated droplets are sprung up by ultrasonic vibration generated in the atomizer 400 and are discharged to the outside of the cartridge 10 through the outlet 160e, may occur in comparative embodiments.

The structure 140 may be arranged in a position adjacent to the discharge passage 150 to limit moving or flowing of the sprung-up droplets in a direction toward the outlet 160e of the mouthpiece 160.

For example, the structure 140 may include a material (e.g., a felt material) that may absorb droplets and may absorb the droplets sprung up from the atomizer 400 to limit moving or flowing of the droplets toward the outlet 160e. However, embodiments are not limited thereto.

When the droplets sprung up from the atomizer 400 are discharged to the outside of the cartridge 10 through the outlet 160e and are delivered to the user in comparative embodiments, the user may feel unpleasant so that the entire sense of smoking may be lowered.

On the other hand, the cartridge 10 according to an embodiment may include the structure 140 that limits moving of the droplets sprung up from the atomizer 400 in the direction toward the outlet 160e, so that lowering of the user's sense of smoking due to liquid sprung may less likely occur. In this disclosure, “liquid sprung” may mean that the droplets that have not been atomized by the atomizer 400 are sprung up, and the corresponding expression may be used in the same sense even below.

The first support unit 141 may accommodate at least one region of the structure 140 and may maintain or fix the accommodated structure 140 in one region of the first housing 110. For example, the first support unit 141 may maintain or fix the structure 140 in one region (e.g., an upper end) of the first housing 110 adjacent to the mouthpiece 160, but embodiments are not limited thereto.

In an embodiment, the first support unit 141 may be arranged to surround at least one region of the structure 140 and may accommodate the structure 140, and as the first support unit 141 for accommodating the structure 140 is combined with one region (e.g., a region in a z direction) of the first housing 110, the structure 140 may be fixed to one region of the first housing 110.

The first support unit 141 for accommodating the structure 140 and the first housing 110 may be coupled to each other in such a way that at least a portion of the first support unit 141 is forcibly fitted into the first housing 110. However, a method of combining the first housing 110 with the first support unit 141 is not limited to the above-described example. In another example, the first housing 110 and the first support unit 141 may also be coupled to each other by using at least one of a snap-fit method, a screw coupling method, and a magnetic force coupling method.

The first support unit 141 may include a material (e.g., rubber) having certain rigidity and waterproofing, may fix the structure 140 to the first housing 110, and may prevent the leakage of the aerosol generating material generated from the storage unit 200. For example, the first support unit 141 may block a region of the storage unit 200 toward the mouthpiece 160, thereby preventing leakage of the aerosol generating material from being generated.

The cartridge 10 according to an embodiment may further include a second support unit 330 for maintaining the liquid delivery element 300 and/or the atomizer 400 in the first housing 110.

The second support unit 330 may be arranged to surround the first liquid delivery element 310, the second liquid delivery element 320, and/or at least a portion of the outer circumferential surface of the atomizer 400, and may accommodate the first liquid delivery element 310, the second liquid delivery element 320, and/or the atomizer 400.

In an embodiment, the second support unit 330 may be coupled to another region (e.g., a region in a −z direction) in an opposite direction to a direction of one region of the first housing 110. As such, the first liquid delivery element 310, the second liquid delivery element 320, and/or the atomizer 400 may be maintained or fixed in another region of the first housing 110.

The second support unit 330 may be coupled to the first housing 110 in such a way that at least a portion of the second support unit 330 is forcibly fitted into the first housing 110. However, a method of coupling the first housing 110 to the second support unit 330 is not limited to the above-described example. In another example, the first housing 110 and the second support unit 330 may also be coupled to each other using at least one of a snap-fit method, a screw coupling method, and a magnetic force coupling method.

In an embodiment, the second support unit 330 may include a material (e.g., rubber) having certain rigidity and waterproofing, may fix the liquid delivery element 300 and the atomizer 400 to the first housing 110, and may prevent the leakage of the aerosol generating material generated in the storage unit 200. For example, the second support unit 330 may block a region of the storage unit 200 adjacent to the liquid delivery element 300 or the atomizer 400, thereby preventing leakage of the aerosol generating material from being generated.

Even when an embodiment is designed to have a constant vibration frequency of the above-described ultrasonic vibrator, there may be an error in manufacturing and production of ultrasonic vibrators. In addition, frequency deviations due to the first conductor 410 or the second conductor 420 described with reference to FIGS. 3 and 4, or an elastic body, may occur.

In an embodiment, before the aerosol generating device is used, or before a preheating operation starts being performed, an operating frequency at which the frequency deviations of the ultrasonic vibrator may be minimized, may be set. For example, when the operating frequency of the aerosol generating device is set to 3.0 MHZ, the frequency of a target ultrasonic vibrator may be 2.9 MHz. This means that a system frequency and a frequency of the vibrator may not be the same due to a loss of a driving circuit of the aerosol generating device.

The following Table 1 represents the relationship between a system setting frequency and an actual frequency.

TABLE 1

| Setting frequency (MHz) | Actual frequency (MHz) |
|---|---|
| 2.9 | 2.828 |
| 3.0 | 2.924 |
| 3.1 | 3.045 |

In an embodiment, the aerosol generating device may set various operation frequencies to be suitable for system performance and design. For example, the operating frequency may be 2.7 MHz to 3.2 MHZ, and a frequency of an available ultrasonic vibrator may be 2.6 MHz to 3.1 MHz. In an embodiment, frequency calibration for compensating for a frequency deviation of the ultrasonic vibrator may be performed before the aerosol generating device is used or before a preheating operation.

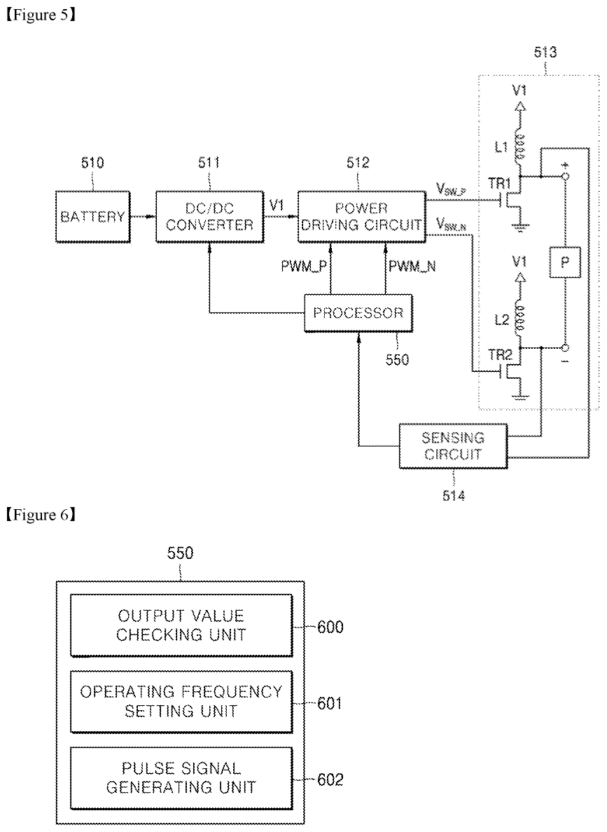

FIG. 5 is a driving circuit diagram for driving an aerosol generating device according to an embodiment. In an embodiment, the aerosol generating device may check an output value according to a pulse signal having a certain frequency and may set an operating frequency based on the checked output value. Here, the certain frequency may be a test frequency for setting the operating frequency. For example, the certain frequency, that is an available frequency range in a device, may be output while changing within the range of, for example, 2.9 MHz to 3.1 MHZ, or may be fixed to 3.0 MHz.

Referring to FIG. 5, the driving circuit may include a battery 510, a DC/DC converter 511, a power driving circuit 512, a processor 550, a boosting circuit 513 including an inductor and a power switch, and a sensing circuit 514. In an embodiment, the processor 550 may output a pulse signal having a certain frequency and may check a frequency of power actually supplied to a vibrator P according to a pulse signal. An output value of actually supplied power therefor, for example, a current value or a voltage value may be checked. In another example, the frequency of the power supplied to the vibrator P may be actually measured and compared.

The DC/DC converter 511 may boost a battery voltage of the battery 510 with a first voltage. The battery voltage may be included in the range of 3.4 V to 4.2 V. However, embodiments are not limited thereto. The battery voltage may be included in the range of 3.8 V to 6 V or may also be included in the range of 2.5 V to 3.6 V. A first voltage V1 may be included in the range of 10 V to 13 V. However, embodiments are not limited thereto. The first voltage V1 may be included in the range of 7 V to 10.5 V, and may also be included in the range of 12 V to 20 V. In an embodiment, the first voltage V1 may be at least three times or more of the battery voltage. However, embodiments are not limited thereto.

The power driving circuit 512 may generate a first switching voltage V_{SW_P} and a second switching voltage V_{SW_N} for switching power switches TR1 and TR2 based on pulse width modulation (PWM) control signals PWM_P and PWM_N input from the processor 550. Here, each of the PWM control signals PWM_P and PWM_N may be a complementary signal. Each of the PWM control signals PWM_P and PWM_N may be a pulse signal having a constant duty ratio or frequency. In an embodiment, the pulse signal for setting the operating frequency in the processor 550 may be a PWM control signal.

A boosting circuit 513 may boost a first voltage V1 output from the DC/DC converter 511 to a second voltage according to the first switching voltage V_{SW_P} and the second switching voltage V_{SW_N} and may apply the boosted second voltage to the vibrator P.

When the first switching voltage V_{SW_P} is in a first state (e.g., a high or low state) and the second switching voltage V_{SW_N} is in a second state (e.g., a low or high state), as a current flow between one of a first inductor L1 and a second inductor L2 and the ground is allowed, an energy corresponding to a change of a current flowing through one inductor may be stored in the one inductor, and as the current flow between the other one of the first inductor L1 and the second inductor L2 and the ground is cut off, an energy stored in the other one inductor may be delivered to the vibrator P.

When the first switching voltage V_{SW_P} is in a high state, a current flow between a source electrode and a drain electrode of a first transistor TR1 may be allowed. Thus, a current flow between the first conductor L1 and the ground may be allowed. The first inductor L1 is connected to the vibrator P, but the vibrator P has a load value (e.g., a capacitance) that is not zero, whereas a resistance of the ground is zero or substantially close to zero so that a current flowing through the first inductor L1 may be substantially delivered to the ground. Because the current flows through the first conductor L1, the first conductor L1 may store energy corresponding to the current. When the second switching voltage V_{SW_N} is in a low state, a current flow between a source electrode and a drain electrode of the second transistor TR2 may be cut off. Thus, energy stored in the second inductor L2 may be supplied to the vibrator P. For example, the current flowing through the vibrator P may correspond to the current flowing through the second inductor L2. In an embodiment, the currents flowing through the first inductor L1 or the second inductor L2 may be output values according to the pulse signal. The processor 550 may detect a current value flowing through the first inductor L1 or the second inductor L2. The processor 550 may estimate the frequency of the vibrator P by referring to a current value table according to the frequency of the vibrator P. Here, the current value table according to the frequency may be a low data value of a current value according to each frequency of the vibrator P that is previously stored.

When the first switching voltage V_{SW_P} is in a low state, a current flow between a source electrode and a drain electrode of the first transistor TR1 may be cut off. Thus, energy stored in the first inductor L1 may be supplied to the vibrator P. For example, the current flowing through the vibrator P may correspond to the current flowing through the first inductor L1.

When the second switching voltage V_{SW_N} is in a high state, a current flow between the source electrode and the drain electrode of the second transistor TR2 may be allowed. Thus, a current flow between the second inductor L2 and the ground may be allowed. The second inductor L2 is also connected to the vibrator P, but the vibrator P has a load value (e.g., a capacitance) that is not zero, whereas a resistance of the ground is zero or substantially close to zero so that a current flowing through the second inductor L2 may be substantially delivered to the ground. Because the current flows through the second conductor L2, the second conductor L2 may store energy corresponding to the current.

Each of the first switching voltage V_{SW_P} and the second switching voltage V_{SW_N} has a frequency corresponding to a PWM signal and corresponds to a voltage signal that repeats a high state or a low state, switching states may be quickly repeated. An inverse power of an inductor may be proportional to an inductance value L of the inductor and a change

$$\frac{di}{( dt )}$$

of current over time, as shown in Equation 1:

$$V = L \frac{di}{dt} \qquad [ Equation 1 ]$$

Thus, the higher the first voltage V1, the higher the current flowing through the inductor, or the higher the switching speed (that is, the shorter the PWM signal), the higher the voltage may be applied to the vibrator P. In an embodiment, a peak-to-peak voltage value of an alternating current applied to the vibrator P may be in the range of 55 V to 70 V. This may be a value in the range of minimum 13.1 times to maximum 20.6 times of the battery voltage (e.g., 3.4 V to 4.2 V).

The sensing circuit 514 may be connected to any side of the vibrator P and may detect a current flowing through the vibrator P by switching of the first transistor T1 or the second transistor T2. Here, the sensing circuit 514, that is a circuit for detecting current, may be a current or voltage amplification circuit. Embodiments are not limited thereto, and other electrical characteristic values or temperature values may also be detected.

For example, hardware of the sensing circuit 514 that may be used in frequency measurement of the vibrator P may be a temperature sensor, a pressure sensor, or a humidity sensor. The temperature sensor may detect the current temperature of the changing vibrator and supply the detected temperature to the processor 550.

The processor 550 may check an output value, for example, a current value, a voltage value, temperature or the like, output from the sensing circuit 514, and may set an operating frequency corresponding thereto. Here, the output value may be converted by an analog-digital converter (ADC). A digital value and a previously-stored data value may be compared with each other. Here, the correlation between an output value and the frequency or operating frequency of the vibrator corresponding thereto may be previously measured experimentally, empirically, or mathematically and may be stored in a memory of the aerosol generating device. The correlation between the output value and the frequency or operating frequency of the vibrator may be stored in the memory in the form of a table, an equation, a matching table or the like.

Referring to FIG. 6, the processor 550 may include an output value checking unit 600, an operating frequency setting unit 601, and a pulse signal generating unit 602.

The output value checking unit 600 may check the output value output by the sensing circuit 514. Here, the output value checking unit 600 may include an amplification circuit, an ADC, etc.

The operating frequency setting unit 601 may compare the checked output value with a previously-stored data value to set the operating frequency. Here, the previously-stored data value may be a value included in the correlation between the above-described output value and the frequency of the vibrator P and the operating frequency.

The pulse signal generating unit 602 may generate a pulse signal corresponding to the set operating frequency, for example, the first and second PWM signals PWM_P and PWM_N described with reference to FIG. 5.

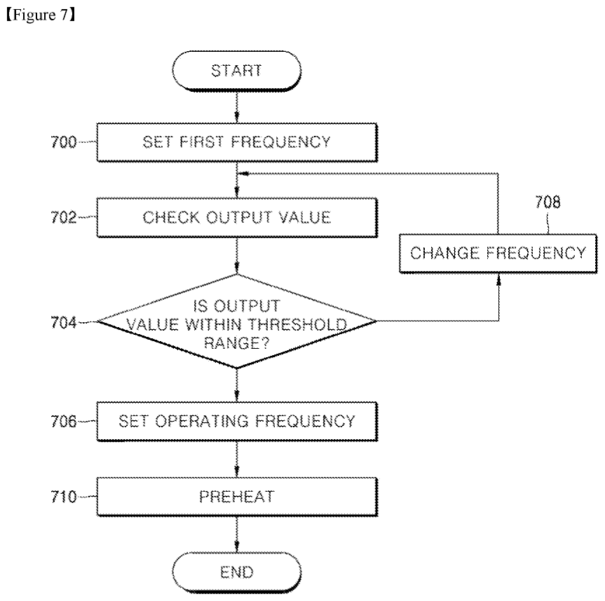

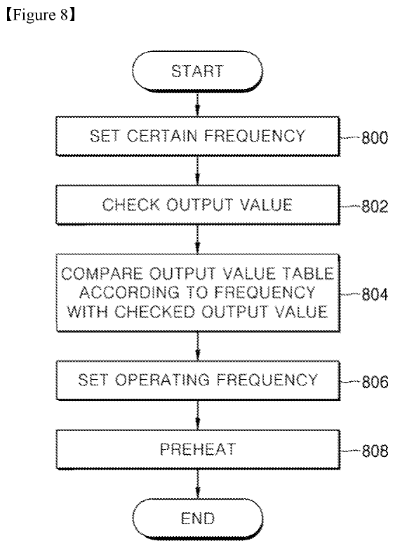

FIGS. 7 and 8 are flowcharts illustrating a frequency calibration method before preheating of an ultrasonic vibrator according to other embodiments.

Referring to FIG. 7, in operation 700, a first frequency may be set.

In operation 702, an output value may be checked.

In operation 704, it may be determined whether the output value is within a threshold range. When the output value is in the threshold range, in operation 706, the first frequency may be set as the operating frequency, and in operation 710, the vibrator may be preheated by using the set operating frequency.

However, when the output value is not within the threshold range, in operation 708, the frequency may be changed into a second frequency, and in operation 702, the output value may be checked, and in operation 704, it may be determined whether the output value is within the threshold range, and when the output value is within the threshold range, in operation 706, the second frequency may be set as the operating frequency.

In the embodiment, while changing the first through N-th frequencies, the operating frequency may be set depending on whether output value is within the threshold range. Here, N may be an integer that is 2 or more. For example, the first frequency may be 3.1 MHZ, the second frequency may be 3.0 MHZ, the third frequency may be 2.9 MHZ, and a frequency change interval may be 0.1 MHz. However, embodiments are not limited thereto. Here, the threshold range may be a range in which values that can be set arbitrarily by vibrator frequency are statistically analyzed.

In an embodiment, in the frequency calibration method described with reference to FIG. 7, the operating frequency may be applied within the range of the preset output value while changing the operating frequency and then the vibrator may be preheated so that a frequency deviation present by an elastic body that is a support structure of the vibrator may be compensated for in advance before power is supplied to the vibrator.

Referring to FIG. 8, in operation 800, a certain frequency may be set. Here, the certain frequency may be a reference frequency that is empirically or experimentally determined. For example, the certain frequency may be 3 MHz. However, embodiments are not limited thereto.

In operation 802, the output value may be checked.

In operation 804, the output value table according to a frequency and the checked output value may be compared with each other. Here, the output value table according to a frequency may include a plurality of operating frequencies and output values corresponding to respective operating frequencies.

In operation 806, the operating frequency may be set.

In operation 808, the vibrator may be preheated by using the set operating frequency.

In an embodiment, in the frequency calibration method described with reference to FIG. 8, the output value may be checked based on the output value for each vibrator frequency, a particular frequency, for example, 3 MHZ, and the output value may be compared with the output value for each vibrator frequency to apply the operating frequency.

In the method of controlling an aerosol generating device described with reference to FIGS. 7 and 8, a frequency deviation of the vibrator P may be calibrated so that accurate frequency correction may be performed according to the deviation of the ultrasonic vibrator P. Therefore, in an operation before the preheating of the vibrator P of the aerosol generating device, an operating frequency may be accurately set.

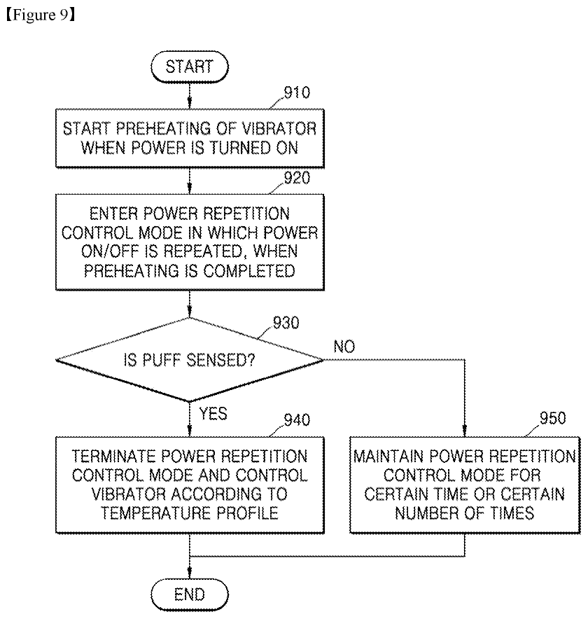

FIG. 9 is a flowchart illustrating another example of a method of controlling an aerosol generating device using an ultrasonic vibrator according to another embodiment.

FIG. 9 schematically illustrates a controlling method that includes the control signal generated by the processor 550 described with reference to FIGS. 1 and 2, and the ultrasonic vibrator may receive the control signal and may operate based on a series of instructions included in the control signal. Hereinafter, an operating process of the ultrasonic vibrator P that receives the control signal will be sequentially described.

First, when power of the aerosol generating device according to an embodiment of the present disclosure is turned off, the ultrasonic vibrator that receives the control signal starts preheating. In operation 910, an operation in which the ultrasonic vibrator receiving the control signal from the processor is preheated, may be referred to as a preheat mode.

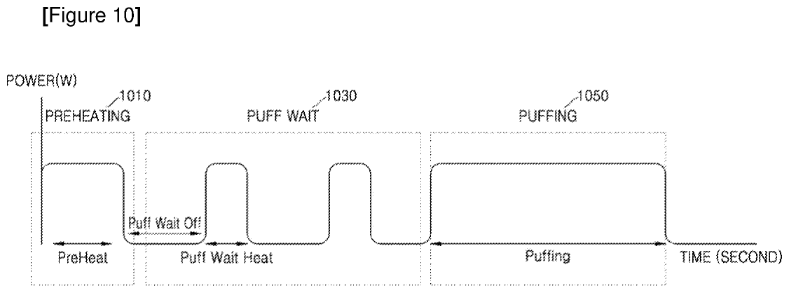

While the preheat mode continues in operation 910, a fixed voltage may be provided to the ultrasonic vibrator. The fixed voltage provided to the ultrasonic vibrator will be described below with reference to FIG. 10.

Subsequently, when preheating of the ultrasonic vibrator is completed, the ultrasonic vibrator may receive the control signal again to enter a power repetition control mode. In operation 920, the power repetition control mode, that is a mode entering after preheating is completed, may mean a mode in which supplying of power to the ultrasonic vibrator or cutting off of the supply of power to the ultrasonic vibrator is alternately repeated. The power repetition control mode is a mode in which the user waits until the user puffs using the aerosol generating device. When the ultrasonic vibrator included in the aerosol generating device receives power continuously even after preheating is completed (when the rated voltage is applied), there is a possibility that temperature rises exponentially and the ultrasonic vibrator may be damaged in comparative embodiments.

In an embodiment, in order to prevent damage of the ultrasonic vibrator, a power repetition control mode, that is an intermediate mode in which the user's inhalation (puff) may be secondarily sensed in a state in which preheating is primarily completed and the user waits for generating of an aerosol, may be included. In particular, in the power repetition control mode, temporarily cutting off of power supply to the ultrasonic vibrator and temporarily restarting of power supply to the ultrasonic vibrator before the effect of preheating is completely lost, is repeated so that the temperature of the ultrasonic vibrator may be prevented from being exponentially increased and damaged, and simultaneously an aerosol may be quickly generated when the user's inhalation is sensed.

In an embodiment, the power repetition control mode is different from a method according to the related art in that a section in which supplying of power to the ultrasonic vibrator is completely cut off after preheating is primarily completed, is provided at least once or more. An aerosol generating device according to the related art using a heater may control the heater by steadily increasing the temperature of the heater to a target temperature using a pulse width modulation (PWM) power signal or a proportional integration differentiation (PID) control method, and even when preheating to the heater is completed in this procedure, power supply to the heater may not be completely cut off (stopped). This is because temperature is kept constant through the ratio of the PWM power signal or PID control.

On the other hand, because the ultrasonic vibration of the aerosol generating device vibrates at a preset frequency, after supplying power to the ultrasonic vibrator for a certain time and then preheating is completed, when the user does not use the device, a section in which supplying of power to the ultrasonic vibrator is cut off for another certain time is provided so that the case where the ultrasonic vibration is overheated and damaged may be minimized. The schematic explanation of the power repetition control mode will be described later with reference to FIG. 10.

In operation 930, the processor 550 may check whether the user's puff is sensed by a variety of puff detection sensors, and when the user's puff is sensed while the ultrasonic vibrator operates in a power repetition control mode, may perform an operation 940 that includes terminating the power repetition control mode and controlling the ultrasonic vibrator so that an aerosol may be generated. In detail, when the user's puff is sensed, the processor 550 may transmit the control signal to the ultrasonic vibrator and may control an operation of the ultrasonic vibrator so that an aerosol may be generated due to vibration of the ultrasonic vibrator according to a preset temperature profile.

In operation 950, when the user's puff is not sensed while the ultrasonic vibrator operates in the power repetition control mode, the processor 550 may terminate the power repetition control mode after repeating the power repetition control mode a certain number of times of repetition (a fixed number of times) or after a certain time (a fixed time) has elapsed.

FIG. 10 is a graph illustrating a controlling method of power supplied to the ultrasonic vibrator shown in FIG. 9.

In FIG. 10, for convenience, the above-described power repetition control mode may be abbreviated as a puff wait mode, and the horizontal axis of FIG. 10 represents time, and the vertical axis of FIG. 10 represents power supplied to the ultrasonic vibrator. In addition, even if it is illustrated that the same power is supplied to the ultrasonic vibrator in various modes of FIG. 10, voltage values applied to the ultrasonic vibrator in the various modes may be different from each other.

As shown in FIG. 10, the ultrasonic vibrator of the aerosol generating device may receive a control signal from the processor 550 and may operate so that an aerosol may be generated via a preheat mode 1010, a puff wait mode 1030, and a puffing mode 1050.

The ultrasonic vibrator may be preheated by receiving fixed power during a period set in the preheat mode 1010. At this time, the voltage applied to supply power to the ultrasonic vibrator may be a value of any one selected from 10 V to 15 V. In an embodiment, the voltage applied to the ultrasonic vibrator in the preheat mode 1010 may be 13 V.

When preheating of the ultrasonic vibrator is completed, the preheat mode 1010 may be terminated, and the puff wait mode 1030 may be entered. In the puff wait mode 1030, a puff wait off section in which the power supply to the ultrasonic vibrator is temporarily cut off, and a puff wait heat section in which power to the ultrasonic vibrator is temporarily resumed following the puff wait off section may be alternately repeated.

The puff wait off section may be a section in which power supplied to the ultrasonic vibrator is temporarily cut off, and a case where the ultrasonic vibrator is damaged due to a sudden increase in temperature while excessively vibrating may be prevented. The puff wait heat section means a section in which power supply to the ultrasonic vibrator is temporarily resumed to convert a state of the ultrasonic vibrator that has been primarily preheated through the preheat mode 1010 to a state that is easy to generate aerosols.

Because the puff wait off section and the puff wait heat section are sections in which power supplied to the ultrasonic vibrator is repeatedly turned on/off, a control signal for implementing the puff wait mode 1030 may be a PWM signal having a constant duty cycle. In an example, the processor 550 may generate a PWM signal having a duty cycle of 50% so as to implement the puff wait mode 1030, and time lengths of the puff wait off section and the puff wait heat section of the ultrasonic vibrator receiving such a control signal may be the same. In another example, the control signal for implementing the puff wait mode 1030 may also be a PWM signal having one value selected from a range of 40% to 60% as a duty cycle.

When the user's inhalation is sensed while operating in the puff wait mode 1030, the ultrasonic vibrator may receive the control signal from the processor 550 to operate in the puffing mode 1050. In the puffing mode 1050, aerosols may be generated by supplying fixed amount of power to the ultrasonic vibrator. When a preset number of puffs ends or a preset puffing time has elapsed, the puffing mode 1050 of the ultrasonic vibrator may be terminated.

As shown in FIG. 10, according to an embodiment, the aerosol generating device may receive the control signal from the processor 550, and may include an ultrasonic vibrator that operates in the puff wait mode 1030 and the puffing mode 1050 so that the overheating of the ultrasonic vibrator may be prevented and an aerosol may be stably supplied to the user. In particular, in the controlling method according to an embodiment of the present disclosure, the puff wait off section and the puff wait heat section may be alternately repeated in the puff wait mode 1030 of the ultrasonic vibrator so that damage of the ultrasonic vibrator may be prevented.

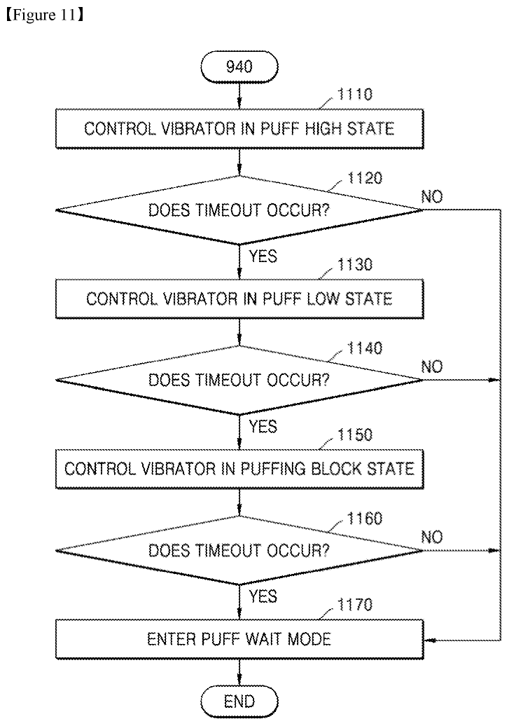

FIG. 11 schematically illustrates a graph of time to power of an ultrasonic vibrator that operates in a puffing mode 1050.

FIG. 11 is a flowchart specifically illustrating another example in which the puffing mode 1050 is implemented in the controlling method described in FIG. 9, and it is assumed that the user's puff is sensed in the puff wait mode 1030 and the ultrasonic vibrator enters the puffing mode 1050.

The control signal of the processor 550 in the puffing mode 1050 may be provided so that the ultrasonic vibrator may enter a puffing high state in operation 1110. In operation 1110, the puffing high state means a state in which relatively high power is supplied to the ultrasonic vibrator for a certain time so that aerosols may be generated by vibration of the ultrasonic vibrator.

In the puffing high state, a preset voltage may be applied to the ultrasonic vibrator for a preset time. For convenience of explanation, the preset voltage applied to the ultrasonic vibrator in the puffing high state and a section in which the voltage is maintained for the preset time, may be referred to as a first voltage and a first section, respectively. In addition, hereinafter, the occurrence of a timeout for a particular state means that a preset maintaining time has elapsed.

Then, when a timeout for the puffing high state occurs in operation 1120, the ultrasonic vibrator may be controlled to a puffing low state by a control signal in operation 1130. Here, in the puffing low state, a preset voltage may be applied to the ultrasonic vibrator for a preset time. For convenience of explanation, in the puffing low state, a preset voltage applied to the ultrasonic vibrator and a section in which the voltage is maintained for a preset time may be referred to as a second voltage and a second section, respectively.

The first voltage applied to the ultrasonic vibrator may be greater than the second voltage. As an example, the first voltage may be one voltage value selected from 12 V to 14 V, and the second voltage may be one voltage value selected from 9 V to 11 V. As another embodiment, the first voltage may be 13 V, and the second voltage may be 10 V. A time length of the first section may be the same as or different from a time length of the second section. In addition, the time lengths of the first section and the second section may be affected by a time length of a blocking section to be described below.

The processor 550 may determine whether a timeout for the second section, that is a maintaining section of the puffing low state, occurs, and when the timeout for the second section occurs in operation 1140, the ultrasonic vibrator may receive a control signal from the processor 550 to enter a puffing block state in operation 1150.

No voltage may be applied to the ultrasonic vibrator operating in the puffing block state. In the puffing block mode, to prevent damage to the ultrasonic vibrator that may be overheated in an operation to generate aerosols, an external signal may be blocked for a certain time period so that the ultrasonic vibrator may not be operated even if there is an input. A section in which the ultrasonic vibrator maintains the puffing block state may be abbreviated as a blocking section.

The processor 550 may determine whether a timeout for the blocking section occurs in operation 1160, and when the timeout for the blocking section occurs, the ultrasonic vibrator may receive a control signal from the processor 550 to enter the puff wait mode in operation 1170. As another example of operation 1170, when a timeout for the blocking section occurs, the aerosol generating device may enter a sleep mode or power thereof may be turned off to minimize power consumption of a battery in preparation for the user's next puff.

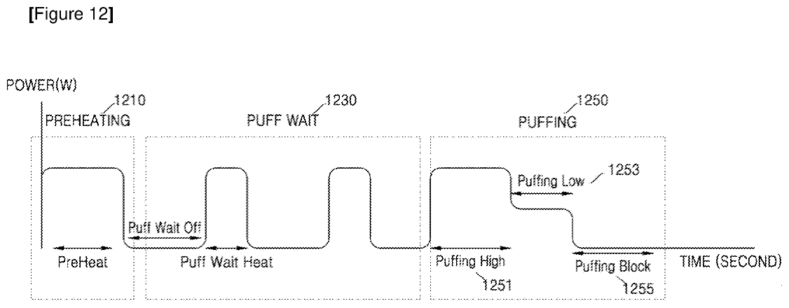

Schematic descriptions of the above-described first section, the second section, and the blocking section are described below with reference to FIG. 12.

FIG. 12 schematically illustrates a graph of time to power of an ultrasonic vibrator that operates in a puffing mode. As shown in FIG. 12, a preheating mode 1220, a puff wait mode 1230, and a puffing mode 1250 may be provided.

The puffing mode of the graph shown in FIG. 12 is different from the puffing mode of the graph shown in FIG. 10. In particular, in the puffing mode 1050 of FIG. 10, a constant voltage may be applied to the ultrasonic vibrator during the puffing mode to generate aerosols, but the puffing mode 1250 of FIG. 12 may be divided into a puffing high state 1251, a puffing low state 1253, and a puffing block state 1255, wherein aerosols are generated through an operation of applying a voltage to the ultrasonic vibrator only in the puffing high state 1251 and the puffing low state 1253, and no voltage may be applied to the ultrasonic vibrator in the puffing block state 1255.

The puffing mode 1250 of FIG. 12 is characterized in being sequentially configured by the puffing high state 1251, the puffing low state 1253, and the puffing block state 1255. Voltages applied to the ultrasonic vibrator in the puffing high state 1251 and the puffing low state 1253 may be a first voltage and a second voltage, respectively, and the first voltage may be one voltage selected from 12 V to 14 V, and the second voltage may be one voltage selected from 9 V to 11 V. In addition, as another example, the first voltage may be 13 V, and the second voltage may be 10 V.

A ratio between the duration of the first section (the duration of the puffing high state 1251), the duration of the second section (the duration of the puffing low state 1253), and the duration of the blocking section (the duration of the puffing block state 1255) may be a preset value. For example, a ratio of time lengths of the first section, the second section, and the blocking section may be 2:3:1. Here, a suitable ratio may be selected as the ratio of the time lengths of the first section, the second section, and the blocking section to prevent the ultrasonic vibrator from being damaged and at the same time to stably generate aerosols, and this ratio may be an experimentally, empirically, and/or mathematically predetermined value.

In FIG. 12, the puffing block state 1255 is similar to the puff wait off section of the puff wait mode 1230 in that the puffing block state 1255 is a section in which no voltage is temporarily applied to the ultrasonic vibrator. However, in the puff wait off section, when the user's puff is sensed, the ultrasonic vibrator may be switched to the puffing mode 1250 to generate an aerosol, whereas, because aerosols have been already generated in the puffing high state 1251 and the puffing low state 1253 set previously, the puffing block state 1255 is a section in which the operation of the ultrasonic vibrator is forcibly blocked, and in the puffing block state 1255, all signals may be blocked even when the user's puff is sensed, so that no voltage may be applied to the ultrasonic vibrator to drive the ultrasonic vibrator.

An operation of the ultrasonic vibrator from the first section to the blocking section of the puffing mode 1250 of FIG. 12 may be performed as follows. For convenience, it may be assumed that the ratio of the time lengths of the first section to the blocking section is 2:3:1 and the first voltage and the second voltage are 13 V and 10 V, respectively.

The ultrasonic vibrator, which has entered the puffing high state 1251, operates for two seconds in a state in which a voltage of 13 V is applied. Subsequently, when a timeout occurs after two seconds have elapsed, the ultrasonic vibrator which has entered the puffing low state 1253 operates for three seconds in a state in which a voltage of 10 V is applied. When a timeout occurs after three seconds have elapsed, no voltage may be applied to the ultrasonic vibrator which has entered the puffing block state 1255, and even when there is an external control signal, all signals may be blocked, and the puffing block state 1255 may be maintained for one second. When a timeout for the puffing block state 1255 occurs, the puffing mode 1250 may be terminated, and the ultrasonic vibrator may be switched to the puff wait mode 1230 as described with reference to FIG. 11.

Through the above operation, the puffing mode 1250 may be accurately controlled, and the ultrasonic vibrator may be prevented from being damaged and aerosols in a uniform atomization amount may be generated each time.

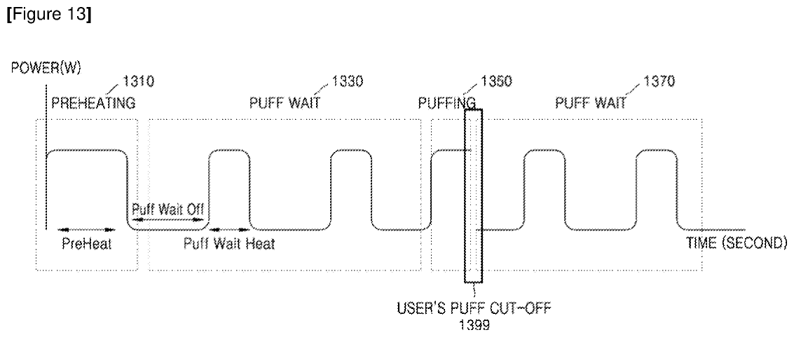

FIG. 13 is a graph illustrating a case where an event occurs in a puffing high state. As shown in FIG. 13, a preheating mode 1310, a puff wait mode 1330, a puffing mode 1350, and a puff wait mode 1370 may be provided.

Specifically, FIG. 13 is a graph schematically showing operating characteristics of the ultrasonic vibrator when the user's inhalation cut-off 1399 is sensed in the puffing high state 1251 of the puffing mode 1250 of FIG. 12 (referred to as a puffing mode 1350 in FIG. 13).

When the processor 550 senses that the user's inhalation is cut off through a puff detection sensor or the like while the ultrasonic vibrator enters a puffing mode 1350 and operates by being applied with the first voltage according to the puffing high state, the puffing mode 1350 may be immediately terminated, and an operation mode of the ultrasonic vibrator may be switched to a puff wait mode 1370. Here, the puff wait mode 1370, that is entered after the puffing mode 1350, has the same characteristics as a puff wait mode 1330 before the puffing mode 1350.

In FIG. 13, a point at which the user's inhalation cut-off 1399 is sensed, may before the timeout for the puffing high state occurs. For example, in the puffing high state maintained at the first voltage for two seconds after switching to the puffing mode 1350, when the user's inhalation cut-off 1399 is sensed within one second after switching to the puffing mode 1350, the ultrasonic vibrator may be controlled to enter the puff wait mode 1370.

A switching algorithm of the puff wait mode 1370 as shown in FIG. 13 may prevent a voltage from being unnecessarily applied to the ultrasonic vibrator and aerosols from being generated even when the user's inhalation is not sensed. In addition, because the puffing low state and the puffing block state are omitted and the ultrasonic vibrator is immediately switched to the puff wait mode 1370, a user may quickly inhale aerosols again.

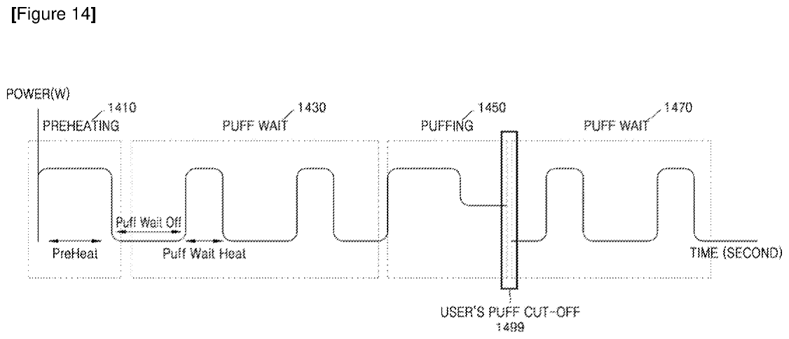

FIG. 14 is a graph illustrating a case where an event occurs in a puffing low state. A shown in FIG. 14, a preheating mode 1410, a puff wait mode 1430, a puffing mode 1450, and a puff wait mode 1470 may be provided.

Specifically, FIG. 14 is a graph schematically showing operating characteristics of the ultrasonic vibrator when the user's inhalation cut-off 1499 is sensed in the puffing low state 1253 of the puffing mode 1250 of FIG. 12 (referred to as a puffing mode 1450 in FIG. 14).

When the processor 550 senses that the user's inhalation is cut off through a puff detection sensor or the like while the ultrasonic vibrator of FIG. 14 enters a puffing mode 1450 and operates by being applied with the second voltage according to the puffing low state, the puffing mode 1450 may be immediately terminated, and an operation mode of the ultrasonic vibrator may be switched to a puff wait mode 1470. Here, the puff wait mode 1470, that is entered after the puffing mode 1450, has the same characteristics as a puff wait mode 1430 before the puffing mode 1450.

In FIG. 14, a point at which the user's inhalation cut-off 1499 is sensed, may before the timeout for the puffing low state occurs. For example, in the puffing low state maintained at the second voltage for three seconds after switching to the puffing mode 1450, when the user's inhalation cut-off 1499 is sensed within two seconds after switching to the puffing low state, the ultrasonic vibrator may be controlled to enter the puff wait mode 1470.

A switching algorithm of the puff wait mode 1470 as shown in FIG. 14 may prevent a voltage from being unnecessarily applied to the ultrasonic vibrator and aerosols from being generated even when the user's inhalation is not sensed. In addition, because the puffing block state is omitted and the ultrasonic vibrator is immediately switched to the puff wait mode 1470, a user may quickly inhale aerosols again.

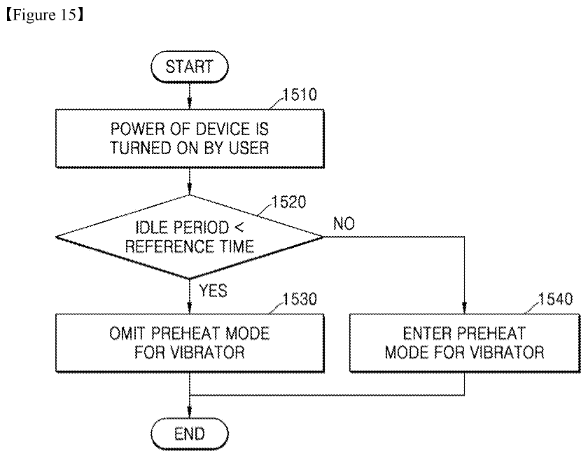

FIG. 15 is a flowchart illustrating another example of a method of controlling an aerosol generating device using an ultrasonic vibrator according to another embodiment.

In more detail, FIG. 15 is a flowchart illustrating an operation in which a preheat mode is omitted and a puff wait mode is immediately entered in the aerosol generating device.

First, in operation 1510, when the power of the aerosol generating device based on ultrasonic vibration is turned on by the user, the processor 550 may determine whether an idle period is less than a reference time in operation 1520.

In operation 1520, the idle period is a time value obtained by counting an elapsed time, and the processor 550 may detect the idle period based on the recent time the aerosol generating device was used. The processor 550 may detect a gap between the recent use time of the aerosol generating device stored in a memory and the current time as the idle period. As another example, the processor 550 may also directly obtain the idle period based on a time counter separately provided to count the idle period.

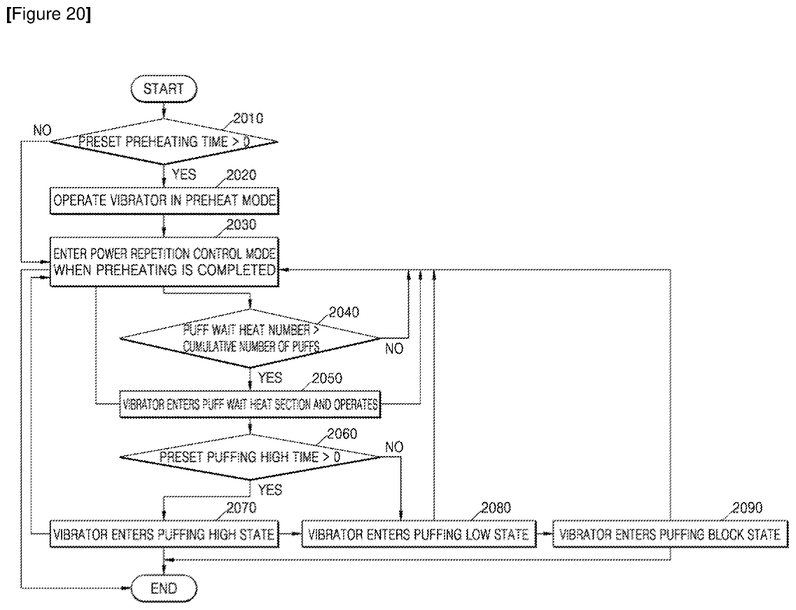

According to an embodiment, in operation 1520, the processor 550 may also determine to omit the preheat mode after determining whether a preset preheating time is set to a value greater than zero second without detecting the idle period and comparing the idle period with the reference time. This embodiment will be described below with reference to FIG. 20.

In operation 1530, when the idle period is less than a preset reference time, the processor 550 may control the ultrasonic vibrator to directly enter the puff wait mode and omit the preheat mode for the ultrasonic vibrator.

On the other hand, in operation 1540, when the idle period is greater than the preset reference time, the processor 550 may control the ultrasonic vibrator to enter the preheat mode to increase the efficiency of aerosol generation.

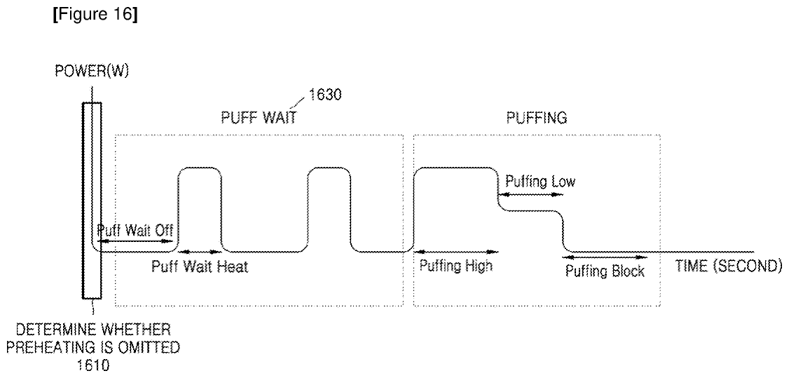

FIG. 16 is a graph illustrating power versus time, in which a preheat mode is omitted. As shown in the FIG. 16, a puff wait mode 1630 and a puffing mode are provided.

Referring to the time axis of the graph of FIG. 16, the processor 550 may determine whether the preheat mode is omitted at a moment when the power of the aerosol generating device is turned on in operation 1610, and as the preheat mode is omitted, it may be seen that the ultrasonic vibrator immediately enters the puff wait mode 1630.

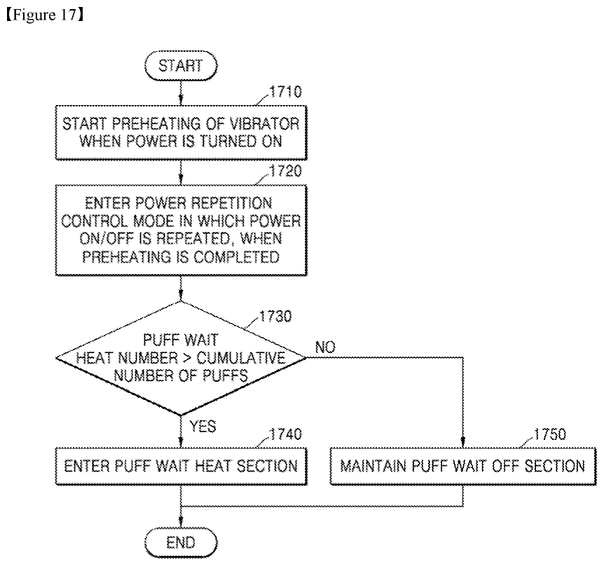

FIG. 17 is a flowchart illustrating another example of a method of controlling an aerosol generating device using an ultrasonic vibrator according to another embodiment.

More specifically, FIG. 17 is a flowchart illustrating an embodiment in which the number of entries of a puff wait heat section in a puff wait mode (power repetition control mode) is predetermined.

In operation 1710, when the power of the aerosol generating device based on ultrasonic vibration is turned on, the processor 550 may control the ultrasonic vibrator to start preheating.

When the preheating of the ultrasonic vibrator is completed, the processor 550 may control the ultrasonic vibrator to enter the power repetition control mode in operation 1720, and may determine whether a preset puff wait heat number is greater than a cumulative number of puffs in operation 1730.

In operation 1730, the puff wait heat number means the number of times the ultrasonic vibrator enters the puff wait heat section in the power repetition control mode, and may be preset. In operation 1730, the cumulative number of puffs is the number of puffs accumulated by the user, and generally becomes zero unless the user continuously uses the device without turning off the power of the aerosol generating device.

When the puff wait heat number is set to an integer value greater than zero, the ultrasonic vibrator may enter the puff wait heat section based on the preset puff wait heat number in operation 1740. In operation 1740, the ultrasonic vibrator may alternately and repeatedly enter the puff wait heat section and the puff wait off section.

On the other hand, when the puff wait heat number is less than the cumulative number of puffs, the ultrasonic vibrator may maintain the puff wait off section in operation 1750. In operation 1750, the puff wait off section may be maintained until the user turns off the power of the device or the user's puff is sensed and the aerosol generating device is switched to the puffing mode.

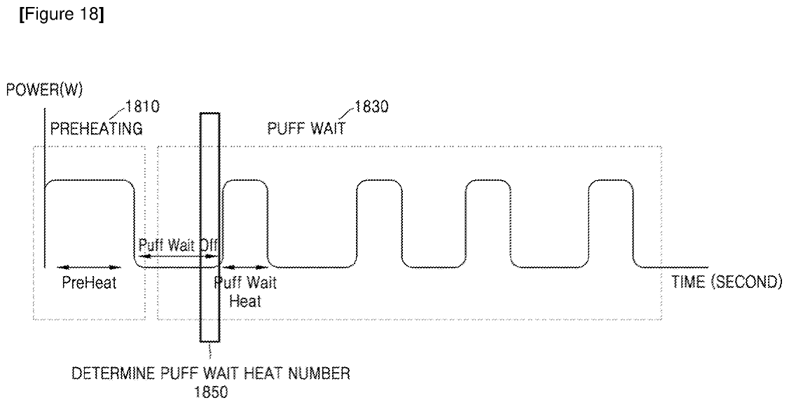

FIG. 18 is a graph illustrating a puff wait heat number described in FIG. 17. As shown in FIG. 18, a preheating mode 1810 and a puff wait mode 1830 may be provided.

Referring to FIG. 18, it may be seen that the ultrasonic vibrator, which has been primarily preheated, may enter the puff wait off section once for device protection and a preset puff wait heat number may be determined by the processor 550 in operation 1850.

In an example, when the puff wait heat number determined by the processor 550 is four and a cumulative number of puffs is zero, the number of times of entries of the puff wait heat section in a puff wait mode 1830 is a total of four times. Thus, as shown in FIG. 18, it may be seen that the ultrasonic vibrator enters the puff wait heat section for a total of four times while alternately entering the puff wait heat section and the puff wait off section.

The embodiment described with reference to FIGS. 17 and 18 may be an embodiment about how many times the puff wait heat section is generated in total until the user's puff is sensed in a state in which the preheating of the ultrasonic vibrator is completed. When an appropriate puff wait heat number is set, wastage of a battery of an aerosol generating device may be prevented while minimizing a length of a puff wait mode.

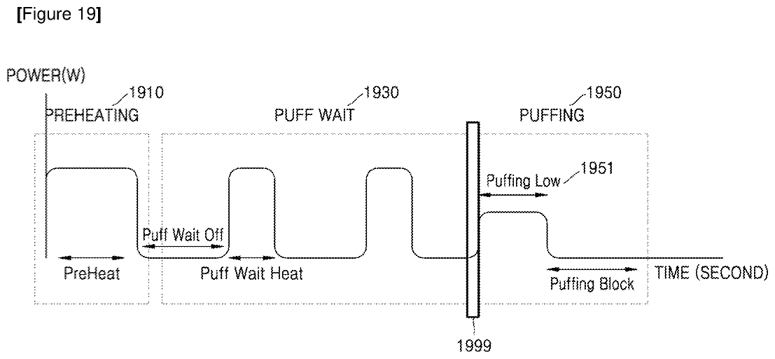

FIG. 19 is a graph of time to power supplied to an ultrasonic vibrator when a puffing high time is set to zero.

As described with reference to FIG. 12, a puffing mode may include a puffing high state, a puffing low state, and a puffing block state. However, when the puffing high time has a duration set to zero, as soon as the ultrasonic vibrator enters the puffing mode, the ultrasonic vibrator may operate by immediately being applied with a voltage according to the puffing low state.

FIG. 19 schematically shows that the duration of the puffing high time is set to zero and a puffing low state 1951 begins at a starting point of the puffing mode 1950. In particular, the processor 550 may check the puffing high time at a point 1999 when a puff is sensed, and may control the ultrasonic vibrator to enter and operate in the puffing low state 1951 based on the duration of the puffing high time being zero.

FIG. 20 is a flowchart comprehensively explaining the embodiments described with reference to FIGS. 9 through 19.

The processor 550 may sequentially and repeatedly control an operation of the ultrasonic vibrator by generating control signals based on a control algorithm as shown in FIG. 20. By the ultrasonic vibrator controlled by a method according to FIG. 20, an aerosol generating device may be prevented from being damaged due to overheating of the ultrasonic vibrator, and at the same time, may be controlled to produce a uniform atomization amount of aerosols for each puff.

First, the processor 550 may determine whether a preset preheating time is greater than zero in operation 2010, and when the preset preheating time is greater than zero, the processor 550 may control the ultrasonic vibrator to operate in the preheat mode in operation 2020.

When a timeout for the preheat mode occurs, the processor 550 may control the ultrasonic vibrator to enter the power repetition control mode (puff wait mode) in operation 2030.

The processor 550 may check whether a preset puff wait heat number is greater than a cumulative number of puffs after a first time of the puff wait off section has elapsed in operation 2040, and when the puff wait heat number is greater than the cumulative number of puffs, may control the ultrasonic vibrator to enter the puff wait heat section and operate in operation 2050.

The processor 550 may control the ultrasonic vibrator to enter the puffing mode and operate when the user's puff is sensed while entering and operating in the puff wait heat section or the puff wait off section.

In addition, the processor 550 may determine whether a duration of a preset puffing high time is greater than zero before the ultrasonic vibrator enters the puffing mode in operation 2060, and only when the duration of the preset puffing high time is greater than zero, the processor 550 may control the ultrasonic vibrator to enter the puffing high state and operate in operation 2070. As an embodiment, a case where the ultrasonic vibrator may be applied with a voltage of 13 V for two seconds in the puffing high state has already been described.

On the other hand, when the duration of the preset puffing high time is not greater than zero or a timeout for the puffing high state of the ultrasonic vibrator occurs, the processor may control the ultrasonic vibrator to enter the puffing low state and operate in operation 2080. As an embodiment, a case where the ultrasonic vibrator may be applied with a voltage of 10 V for three seconds in the puffing low state has already been described.

When a timeout for the puffing low state of the ultrasonic vibrator occurs, the processor 550 may control the ultrasonic vibrator to enter the puffing block state in operation 2090. It has been described herein that the ultrasonic vibrator, which has entered the puffing block state, may block a control signal for the ultrasonic vibrator for a certain period of time to protect the ultrasonic vibrator from being overheated while generating aerosols.

In an embodiment, the aerosol generating device that is a device operating in a preheat mode, a power repetition control mode (puff wait mode), and a puffing mode, may include a control algorithm that prevents damage due to overheating of a vibrator and ensure a uniform atomization amount of aerosols for each puff. In particular, the aerosol generating device according to embodiments of the present disclosure may prevent overheating of the ultrasonic vibrator by entering a puff wait off section at least once after the primary preheating is completed, and may block all user input by separately placing the vibrator into a puffing block state after the user's puff is completed and prevent a consuming use of the aerosol generating device.

In addition, the aerosol generating device according to embodiments of the present disclosure may further include a control algorithm that does not unnecessarily maintain the puffing mode when the user's inhalation is sensed and then quickly cut off.

Those of ordinary skill in the art related to the present embodiments understand that various changes in form and details can be made to embodiments of the present disclosure without departing from the scope of the present disclosure. The disclosed methods should be considered in descriptive sense only and not for purposes of limitation.

1. An aerosol generating device comprising:
a storage unit in which an aerosol generating material is stored;
a liquid delivery element configured to absorb the aerosol generating material stored in the storage unit;
an atomizer comprising a vibrator configured to generate ultrasonic vibration and atomize the aerosol generating material absorbed by the liquid delivery element with an aerosol; and
a processor configured to control power supplied to the vibrator,
wherein the processor is further configured to check an output value in response to a pulse signal having a certain frequency and set an operating frequency based on the checked output value.

2. The aerosol generating device of claim 1, wherein the operating frequency is a frequency of the pulse signal for preheating the vibrator.

3. The aerosol generating device of claim 1, wherein the processor is further configured to output pulse signals having a plurality of frequencies for a test so as to set the operating frequency and set the operating frequency depending on whether each output value is within a threshold range.

4. The aerosol generating device of claim 1, wherein the processor is further configured to output a pulse signal having a frequency of a certain size and check an output value of power supplied to the vibrator, and compare a target output value corresponding to the previously-stored operating frequency with the checked output value and set the operating frequency according to a comparison result.

5. The aerosol generating device of claim 1, wherein the processor is further configured to output a pulse signal corresponding to the set operating frequency.

6. The aerosol generating device of claim 1, further comprising a sensing circuit configured to sense an output value of an input side of the vibrator.

7. The aerosol generating device of claim 6, wherein the output value is a current value or a voltage value sensed at the input side of the vibrator.

8. The aerosol generating device of claim 7, wherein the processor is further configured to convert the sensed current value or voltage value into a digital value and compare the converted digital value with a digital value for each previously-stored frequency to set the operating frequency.

9. The aerosol generating device of claim 1, wherein the operating frequency is a value within a range of 2.7 MHz to 3.2 MHz.

10. The aerosol generating device of claim 9, wherein a vibration frequency of the vibrator is a value within a range of 2.6 MHz to 3.1 MHz.

11. A method of controlling the aerosol generating device of claim 1, the method comprising:
outputting a pulse signal corresponding to a first frequency by using the processor;
checking an output value of power supplied to the vibrator by using the processor; and
determining whether the output value is within a preset threshold range and setting an operating frequency according to a determination result by using the processor,
wherein, when the output value is within a preset threshold range, the operating frequency is set, and when the output value is not within the preset threshold range, a current frequency is changed into a second frequency that is different from the first frequency and an output value of power supplied to the vibrator is checked.

12. A method of controlling the aerosol generating device of claim 1, the method comprising:
outputting a pulse signal corresponding to a first frequency by using the processor;
checking an output value of power supplied to the vibrator by using the processor;
comparing the checked output value with an output value of an output value table for each previously-stored frequency; and
setting the operating frequency according to the comparison result.
